(19) United States
(12) Patent Application Publication
(10) Pub. No.: US 2026/0064755 A1
(43) Pub. Date: Mar. 5, 2026

(54) SYSTEMS AND METHODS FOR CONTENT SUMMARIZATION

(71) Applicant: Expedia, Inc., Seattle, WA (US)

(72) Inventors: Srinivas Billa, Milton Keynes (GB); Rajesh Kumar Gupta Lakshminarayan Gupta, Waterloo (CA)

(73) Assignee: Expedia, Inc., Seattle, WA (US)

(21) Appl. No.: 19/313,456

(22) Filed: Aug. 28, 2025

Related U.S. Application Data
(60) Provisional application No. 63/689,139, filed on Aug. 30, 2024.

(51) Int. Cl. G06F 16/34; G06F 9/451; G06F 40/30

(52) U.S. Cl. CPC G06F 16/345; G06F 9/451; G06F 40/30

(57) ABSTRACT

Systems and methods for generating content summaries are provided. A provider computing system includes a first machine learning model configured to: retrieve one or more elements associated with an entity and retrieve a plurality of content items associated with the entity, each content item including a reference to at least one of the one or more elements; a second machine learning model configured to determine, for each reference to at least one of the one or more elements in each content item of the plurality of content items, a sentiment of the reference; a third machine learning model configured to generate, for each reference to the at least one of the one or more elements, a first summary of the at least one of the one or more elements; and a fourth machine learning model configured to: generate a second summary, including the first summary.

### CROSS-REFERENCE TO RELATED APPLICATION

This application claims the benefit of and priority to U.S. Provisional Application No. 63/689,139, filed Aug. 30, 2025, which is incorporated herein by reference in its entirety and for all purposes.

### TECHNICAL FIELD

Embodiments and aspects of the present disclosure relate generally to systems and methods for improved graphical user interfaces including using content summarizers.

### BACKGROUND

Users may view content generated by others when making a decision about whether to purchase an item. Large amounts of content associated with the item may make it difficult for the user to view the content and make an accurate judgement about whether or not to purchase the item.

### SUMMARY

Aspects and embodiments of the present disclosure relate generally to improved graphical user interfaces using content summarizers. One embodiment relates to a system for generating content summaries. The system includes a provider computing system including: a first machine learning model configured to: retrieve, from a third party, one or more elements associated with an entity, and retrieve a plurality of content items associated with the entity, each content item of the plurality of content items including a reference to at least one of the one or more elements; a second machine learning model configured to determine, for each reference to at least one of the one or more elements in each content item of the plurality of content items, a sentiment of the reference; a third machine learning model configured to generate, for each reference to the at least one of the one or more elements, a first summary of the at least one of the one or more elements;

and a fourth machine learning model configured to generate a second summary, the second summary including the first summary of the at least one of the one or more elements.

Another aspect relates to a method for generating content summaries including: retrieving, by a first machine learning model, from a third party, one or more elements associated with an entity, and retrieving, by the first machine learning model, from a provider computing system, a plurality of content items associated with the entity, each content item of the plurality of content items including a reference to at least one of the one or more elements, determining, by a second machine learning model, for each reference to at least one of the one or more elements in each content item of the plurality of content items, a sentiment of the reference, generating, by a third machine learning model, for each reference to the at least one of the one or more elements, a first summary of the at least one of the one or more elements, and generating, by a fourth machine learning model, a second summary, the second summary including the first summary of the at least one of the one or more elements.

Another aspect relates to one or more non-transitory computer-readable media storing instructions thereon that, when executed by one or more processors, cause the one or more processors to perform operations including: retrieving, by a first machine learning model, from a third party, one or more elements associated with an entity, and retrieving, by the first machine learning model, from a provider computing system, a plurality of content items associated with the entity, each content item of the plurality of content items including a reference to at least one of the one or more elements, determining, by a second machine learning model, for each reference to at least one of the one or more elements in each content item of the plurality of content items, a sentiment of the reference, generating, by a third machine learning model, for each reference to the at least one of the one or more elements, a first summary of the at least one of the one or more elements, and generating, by a fourth machine learning model, a second summary, the second summary including the first summary of the at least one of the one or more elements.

In some embodiments, determining the sentiment of the reference further includes: weighting each content item of the plurality of content items based on an age of each content item, wherein the first summary is generated using the weight of each content item.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 depicts a block diagram of a system for improving graphical user interfaces via content summarizers, according to an example embodiment.

FIG. 2 depicts a block diagram of the content summarizer of the system of FIG. 1, according to an example embodiment.

FIG. 3 depicts a flow diagram of a method of improving graphical user interfaces via content summarization, according to an example embodiment.

FIG. 4 depicts a flow diagram of a method of content selection for improving graphical user interfaces via content summarization, according to an example embodiment.

FIG. 5 depicts a flow diagram of a method of sentiment analysis and verbatim extraction for improving graphical user interfaces via content, according to an example embodiment.

FIG. 6 depicts a flow diagram of a method of summarization for improving graphical user interfaces via content summarization, according to an example embodiment.

FIG. 7 depicts a user interface, according to an example embodiment.

FIG. 8 depicts another user interface, according to an example embodiment.

FIGS. 9A and 9B depict another user interface, according to an example embodiment.

FIG. 10 depicts another user interface, according to an example embodiment.

FIGS. 11A-11C depict another user interface, or portions thereof, according to an example embodiment.

FIGS. 12A-12D depict another user interface, or portions thereof, according to an example embodiment.

FIG. 13A-13D depict another user interface, or portions thereof, according to an example embodiment.

FIGS. 14A-14D depict another user interface, or portions thereof, according to an example embodiment.

FIG. 15 depicts another user interface, according to an example embodiment.

FIG. 16 depicts another user interface, according to an example embodiment.

FIG. 17A depicts elements of a user interface, according to an example embodiment.

FIG. 17B depicts elements of a user interface, according to an example embodiment.

FIG. 17C depicts elements of a user interface, according to an example embodiment.

FIG. 18A depicts elements of a user interface, according to an example embodiment.

FIG. 18B depicts elements of a user interface, according to an example embodiment.

FIG. 18C depicts elements of a user interface, according to an example embodiment.

FIG. 19 depicts still another user interface, according to an example embodiment.

### DETAILED DESCRIPTION

Below are detailed descriptions of various concepts related to and implementations of techniques, approaches, methods, apparatuses, and systems for training and/or utilizing artificial intelligence (AI) systems, specifically large language models (LLMs) for content summarization and graphical user interface element minimization and/or consolidation in order to, among other benefits, improve graphical user interfaces. In one example implement, the methods, apparatuses, and systems for training and/or utilizing artificial intelligence (AI) systems, specifically LLMs, may be operable to aggregate reviews regarding a travel object (e.g., a property, such as a vacation house, a hotel, etc.) and generate a summary of the aggregated reviews in a predefined area of a graphical user interface in order to decrease the space occupied by the reviews in conventional graphical user interfaces to enable more content to be added to the graphical user interface and make the graphical user interface more digestible for consumers (travelers, in this example). The various concepts introduced above and discussed in detail below may be implemented in any of numerous ways, as the described concepts are not limited to any particular manner of implementation. Examples of specific implementations and applications are provided primarily for illustrative purposes.

Referring generally to the Figures, aspects and embodiments of the present disclosure relate to systems, computer-readable media, and methods that improve graphical user interfaces via content summarization. Specifically, a plurality of LLMs can be used to obtain content from various sources (e.g., different websites, different third party providers, etc.), analyze the content, and provide a summary of the content. When a user is faced with making a purchase, they may search for reviews or user experiences from those that have previously purchased the item. Consequently, a user may visit multiple web pages and read multiple (e.g., tens, hundreds) pieces of content (e.g., reviews) to inform their purchase. Given a large volume of content, a user may be unable to view all of the content items and be unable to draw a complete or accurate conclusion of what previous users or customers have to say about the purchase, making it difficult for the user to be sure that they are making a purchase that they will be satisfied with. The systems and methods describe herein provide a way of consolidating, onto one graphical user interface (GUI), a plurality of pieces of content in the form of one or more summaries generated by an LLM. Providing summaries based on large amounts of content makes it easier for a user to digest the large quantities of content and reduces an amount of time it takes for a user to make a decision on whether or not to make a purchase.

The content summarizers may also provide technological improvements to the computing systems that house the content summarizers. For example, the content summarizers provide a method of fact checking. The content summarizers utilize content from a specific period of time (e.g., years). Within the period of time, elements of the reviews may become outdated, for example when an aspect of the item being reviewed is changed or updated. The content summarizers can receive an indication that a review is outdated and omit the review and/or outdated content from being included in the generated summary. Thus, a user can be sure that they are viewing an updated, accurate representation of the summarized content. Additionally, the content summarizers employ a weighting system when determining sentiment of aspects of the content to be summarized. For example, content (e.g., a review, text from a review) produced more recently is given more weight in determining a sentiment associated with an aspect of the item being summarized compared to content produced less recently. The weighting system provides another method of providing an accurate, up-to-date GUI for the user.

Based on the foregoing, one particular implementation may be specific to travel. According to some example embodiments, user research into a rental or vacation property is improved by leveraging user-submitted property reviews to generate an overview of the property based on a plurality of user reviews. Specifically, the system can utilize a plurality of LLMs to retrieve reviews for a property, analyze each review to determine a sentiment of the review and extract verbatim text from the review, and generate an overall summary reflective of all of the reviews for the property. This aggregation and artificial intelligence (AI)-based summary generation can aid users in selecting a property to book or rent for a vacation, particularly when the user is searching through multiple potential properties, as well as when each potential property has a large number of reviews.

Currently, travelers may be required to read through multiple (e.g., tens, hundreds, etc.) reviews of a property to understand, determine, or estimate the quality and experience provided by a property, and whether the property will meet their specific needs. This can be time-consuming and painful for many travelers. However, guest reviews are perceived to be more reliable than property descriptions on the associated web page or site, as they help to build trust and confidence in the property. Therefore, reading guest reviews of a property may be important to a user in determining whether or not to book a property. The systems and methods described herein leverage LLMs to parse through reviews for a property and provide a user with an accurate representation of the property.

Before turning to the Figures, which illustrate certain example embodiments in detail, it should be understood that the present disclosure is not limited to the details or methodology set forth in the description or illustrated in the Figures. It should also be understood that the terminology used herein is for the purpose of description only and should not be regarded as limiting.

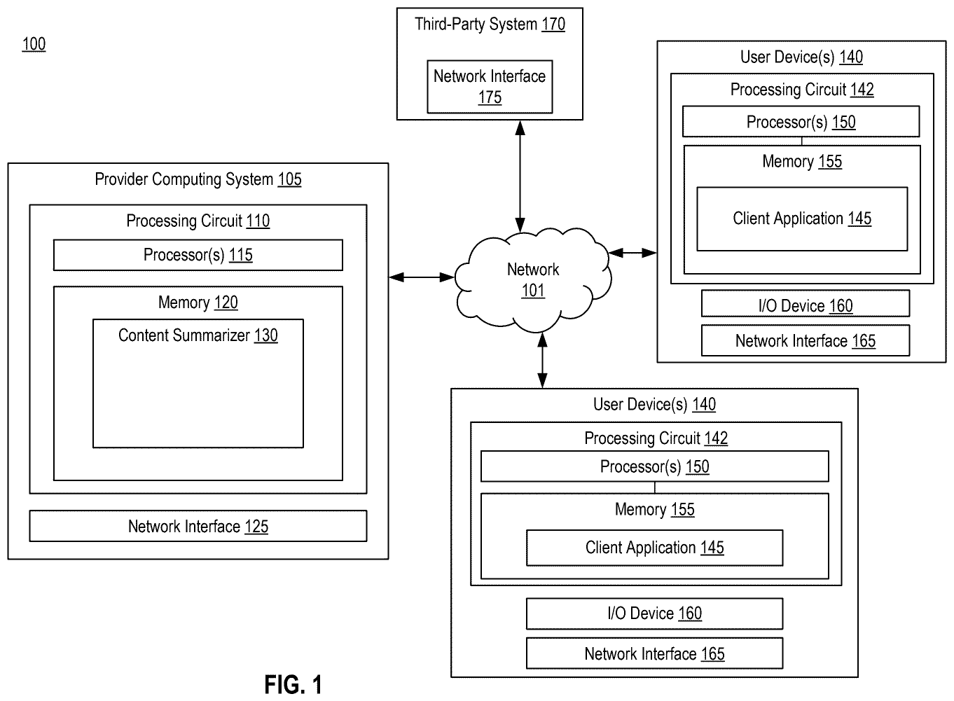

FIG. 1 illustrates an example system 100 for improving graphical user interfaces via content summarization. Specifically, content summarizers employ, train, and/or provide a machine learning model (e.g., a content summarizer) to generate summaries of content for display to a user via a GUI. As will be discussed herein, the content summarizer may generate summaries of property reviews based on reviews left by individual users. For example, in some implementations, various components and/or systems of the system 100 may be configured to generate and provide summaries for properties associated with booking lodging for travel (e.g., hotels, vacation rentals, resorts, etc.). However, it should be understood that the systems and methods described herein are not limited to generating content summaries for travel-related uses, such as vacation property booking, but can be applied to generating summaries for any type of content (e.g., products to be purchased, goods, services, etc.).

According to some embodiments and as shown, the system 100 includes a provider computing system 105 coupled to one or more user devices 140 and one or more third-party systems 170 via a network 101. The provider computing system 105 may be a computing system associated with a provider entity. The provider organization or entity may be a provider of goods and/or services. In this example, the provider entity is a travel services/experiences provider, such as a travel agency or travel broker (e.g., a company that allows users to book travel services provided by other companies), which provides and maintains one or more accounts on behalf of the user. The provider may be a transportation provider (e.g., airline, car or rental vehicle service, rideshare/taxi service etc.), a lodging provider (e.g., hotel, rental property, cruise, etc.), an experience provider (e.g., theme parks, concerts, shows, events, excursions, etc.), or any combination thereof. In the example shown, the provider is a travel or experience booking agency that provides or enables a variety of experiences by interfacing/communicating with other providers (e.g., lodging providers, airline providers, etc.). As described herein, in some implementations, various components and/or systems of the system 100 may be configured to generate and provide summaries for travel experiences (e.g., reviews regarding travel properties, travel excursions, etc.).

The provider computing system 105 can include at least one processing circuit 110, which may, as an example, include at least one processor 115 and at least one memory 120. The provider computing system 105 may include one or more servers that include one or more of the processors and/or memory components described above and herein. The memory 120 can store computer-executable instructions that, when executed by the processor 115, cause the processor 115 to perform one or more of the operations described herein. The processor 115 may include a microprocessor, an application-specific integrated circuit (ASIC), a field-programmable gate array (FPGA), a graphics processing unit (GPU), a tensor processing unit (TPU), etc., and/or combinations thereof. The memory 120 may include, but is not limited to, electronic, optical, magnetic, or any other storage or transmission device capable of providing the processor 115 with program instructions. The memory 120 may further include a magnetic disk, memory chip, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The provider computing system 105 can include one or more computing devices or servers that can perform various of the operations or functions described herein. The memory 120 may store a content summarizer 130, which will be described in greater detail herein.

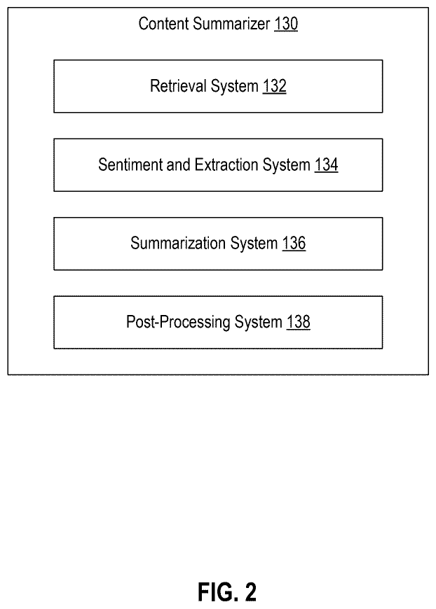

The provider computing system 105 can be structured as one or more backend computing systems including one or more servers and other computing components, in some embodiments. The provider computing system 105 (e.g., the memory 120) may include a content summarizer 130 that may utilize a plurality of user reviews (e.g., regarding a travel experience, such as a travel property) and generate a limited, such as a single summary of the travel experience (e.g., travel property) based on the plurality of individual reviews. Regarding reviews of travel properties, in some embodiments, the content summarizer 130 may additionally generate at least one summary for one or more amenities or aspects of the travel property. For example, the content summarizer 130 may generate at least one summary for amenities, such as a pool, dining facilities, parking, cleanliness, etc. Though the content summarizer 130 is described as generating summaries for properties and lodging, it should be understood that the content summarizer 130 may generate summaries for other travel bookings. For example, the content summarizer 130 may generate summaries for travel properties (rentals, hotel rooms, etc.), rental car companies, airlines, airlines for specific trips, restaurants, experiences, excursions (e.g., a trip to a waterfall, landmarks, hikes, etc.) etc. In some embodiments, the content summarizer 130 may generate summaries for individual units of a travel property. For example, the content summarizer 130 may generate summaries for specific rooms or types of rooms in a hotel or another property. The rooms may be lodging rooms, meeting rooms, and/or any other type of room. The content summarizer 130 may utilize a plurality of LLMs to retrieve user reviews associated with the property, determine a sentiment of each of the reviews, extract text from each of the reviews, and subsequently generate a summary of the property based on the analyzed reviews. In some embodiments, each of the individual user reviews and/or the generated summary may be post-processed to refine the summary, such as by performing content validation and toxicity checking. The property review summarizer will be described in greater detail with respect to FIG. 2.

The provider computing system 105 can include a network interface 125. In some instances, the network interface 125 includes, for example, program logic and any associated hardware components (e.g., transceivers, ethernet cards, etc.) that connects the provider computing system 105 to the network 101. The network interface 125 facilitates secure communications between the provider computing system 105 and each of the user device(s) 140 and third party system(s) 170. The network interface 125 also facilitates communication with other entities, such as other providers of goods and/or services. The network interface 125 further includes user interface program logic configured to generate and present web pages to users accessing the provider computing system 105 over the network 101.

The network 101 can include packet-switching computer networks such as the Internet, local, wide, metro, or other area networks, intranets, satellite networks, other computer networks such as voice or data mobile phone communication networks, or combinations thereof. The provider computing system 105 of the system 100 can communicate via the network 101 with one or more computing devices, such as the one or more user devices 140 and the one or more third-party systems 170. The network 101 may be any form of computer network that can relay information between the provider computing system 105, the one or more user devices 140, the one or more third-party systems 170, and one or more information sources, such as web servers or external databases, amongst others. In some implementations, the network 101 may include the Internet and/or other types of data networks, such as a local area network (LAN), a wide area network (WAN), a cellular network, a satellite network, or other types of data networks. The network 101 may also include any number of computing devices (e.g., computers, servers, routers, network switches, etc.) that are configured to receive or transmit data within the network 101.

The network 101 may include any number of hardwired or wireless connections. Any or all of the computing devices described herein (e.g., the provider computing system 105, the one or more user devices 140, the one or more third-party systems 170, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 101. Any or all of the computing devices described herein (e.g., the provider computing system 105, the one or more user devices 140, the one or more third-party systems 170, etc.) may also communicate wirelessly with the computing devices of the network 101 via a proxy device (e.g., a router, network switch, or gateway). In some embodiments, a wired or a combination of wired and/or wireless connections may be used to enable communicable coupling.

The system 100 is shown to include a plurality of user devices 140. The user device 140 may be owned by, managed by, and/or otherwise associated with a user. As the provider is a travel experience provider in this example, the user may be a customer of the travel experience provider. For example, the user may be an individual, a representative of an entity, and/or another type of user. The user may view or browse a website and/or mobile application associated with the travel experience provider. Specifically, the user may be viewing the website or mobile application associated with the travel experience provider to view properties and book a property.

The user device 140 may be one or more computing devices that can perform various operations as described herein. For example, in some implementations, the user device 140 may be or may include, for example, a desktop or laptop computer (e.g., a tablet computer), a smartphone, a wearable device (e.g., a smartwatch), a personal digital assistant, and/or any other suitable computing device. In the example shown, the user device 140 is structured as a computing device, namely a mobile device (e.g., a smartphone).

Each of the user devices 140 can include at least one processing circuit 142, at least one processor (e.g., processor(s) 150), and at least one memory (e.g., memory 155). The memory 155 may, as an example, include at least one client application (e.g., client application 145). In some implementations, one or more of the user devices 140 can access various functions of the provider computing system 105 through the network 101. For example, the user device 140 can access one or more functions of the provider computing system 105 via the client application 145 of the user device 140 that is configured to display various user interfaces to the user device 140 via the network 101.

The client application 145 can be coupled to and supported, at least partly, by the provider computing system 105. For example, in operation, the client application 145 can be communicably coupled to the provider computing system 105 and may perform certain operations described herein. In some embodiments, the client application 145 includes program logic stored in a system memory (e.g., memory 155) of the user device 140. In such arrangements, the program logic may configure a processor (e.g., processor(s) 150) of the user device 140 to perform at least some of the functions discussed herein with respect to the client application 145 of the user device 140. In the example shown, the client application 145 may be downloaded from an application store, stored in the memory 155 of the user device 140, and selectively executed by the processor(s) 150. In other embodiments, the client application 145 may be hard-coded into the user device 140. In still various other embodiments, the client application 145 is a web-based application.

As alluded to above, the client application 145 may be provided by the provider associated with the provider computing system 105 such that the client application 145 supports at least some of the functionalities and operations described herein with respect to the provider computing system 105. In this way, the client application 145 may also be referred to as a provider institution client application or provider client application. In some embodiments, the client application 145 may be accessed and executed by the processor(s) 150 responsive to receiving various credentials of a user to access the client application 145 (e.g., a username, a password, a pin code, a biometric such as a facial scan or a fingerprint, a combination thereof, etc.).

In some instances, the client application 145 may additionally be coupled to the third-party system(s) 170 (e.g., via one or more application programming interfaces (APIs) and/or software development kits (SDKs)) to integrate one or more features or services provided by the third-party system(s) 170. In some instances, the third-party system(s) 170 may alternatively and/or additionally provide services via a separate client application 145. For example, the client application 145 may initiate an API call to the third-party system 170 to retrieve API information related to reviews for the property left on a website not associated with the provider.

The processor(s) 150 can include a microprocessor, an ASIC, an FPGA, a GPU, a TPU, etc., or combinations thereof. The memory 155 can store processor-executable instructions that, when executed by the processor(s) 150, cause the processor(s) 150 to perform one or more of the operations described herein. The memory 155 can include, but is not limited to, electronic, optical, magnetic, or any other storage or transmission device capable of providing the processor 150 with program instructions. The memory 155 can further include a memory chip, ROM, RAM, EEPROM, EPROM, flash memory, optical media, or any other suitable memory from which the processor(s) 150 can read instructions. The instructions can include code from any suitable computer programming language.

The user device 140 is further shown as including an I/O device 160 and a network interface 165. The I/O device 160 can include various components for receiving inputs, providing outputs, or receiving and providing inputs and outputs, respectively, to a user of the user device 140. For example, the I/O device 160 can include a display screen such as a touchscreen, a mouse, a button, a keyboard, a microphone, a speaker, an accelerometer, actuators (e.g., vibration motors), any combination thereof, etc. The I/O device 160 may also include circuitry/programming/etc. for operating such components. The I/O device 160 thereby enables communications to and from a user, for example communications relating to travel recommendations as described in further detail herein.

The network interface 165 includes, for example, program logic and various devices and/or components and systems (e.g., transceivers, etc.) that connect the user device 140 to the network 101. The network interface 165 facilitates secure communications between the user device 140 and each of the provider computing system 105 and/or the third-party system 170. The network interface 165 also facilitates communication with other entities, such as other providers of goods and/or services.

The system 100 is shown to include the third-party system 170 (although only one is shown, there could be a plurality or, in some embodiments, none). The third-party system or third-party computing system 170 may be a third party relative to the provider and may be associated with a third-party entity. For example, the third-party entity may be or may include various goods and/or services provider entities including, but not limited to, a transportation provider (e.g., airline, car service, etc.), a lodging provider (e.g., hotel, rental property, cruise, etc.), an experience provider (e.g., theme parks, concerts, shows, events, excursions, etc.), or any combination thereof. The provider computing system 105 may communicate with the third-party system 170 to make bookings and reserve experiences on behalf of the traveler/user. The third-party system 170 includes a respective network interface 175 to facilitate exchanging data with the provider computing system 105 and/or the user device 140 through the network 101. The third-party system 170 may include one or more servers. The third-party system 170 may include one or more APIs and/or SDKs associated with the third-party entity for exchanging data with the provider computing system 105 and/or the user device 140, as described herein.

Referring now to FIG. 2, a block diagram of the content summarizer 130 is shown, according to an example embodiment. The content summarizer 130 may generate or cause a generation, and provide a summary of a travel experience (e.g., a travel property) based on individual reviews left for the property.

The content summarizer 130 may include at least a retrieval system 132, a sentiment and extraction system 134, a summarization system 136, and/or a post-processing system 138. Each of the systems 132-138 may be or include one or more LLMs trained to perform the activities described herein. The LLMs may be trained, for example, with reference summaries written by human agents (e.g., annotators). In various embodiments, the systems 132-138 (e.g., the LLMs) may not be part of the provider computing system 105 but instead may be third-party LLMs that are accessed by the provider computing system 105. Additionally or alternatively, in some embodiments, the systems 132-138 (e.g., the LLMs) may be one or more circuits as the term “circuits” is defined herein as opposed to being stored in the memory 120.

The systems 132-138 may include, but are not limited to, large language models (LLMs), which are capable of processing complex input prompts and generating human-like responses and can be trained to generate human-like text, speech, images, or components of graphical user interfaces. The systems 132-138 may be structured using a deep learning architecture that includes a multitude of interconnected layers, including transformer layers, attention mechanisms, self-attention layers, and transformer blocks. The systems 132-138 are trained on large datasets to assimilate patterns, structures, and relationships within large corpuses of text data.

The LLMs (e.g., systems 132-138) may be trained to generate outputs that closely resemble the characteristics of the input data. The systems 132-138 may be fine-tuned to generate specific output data, including data that is compatible with various database architectures or augmented reality systems. The systems 132-138 can be trained via optimization of a large number of parameters, in which the systems 132-138 learn to minimize the error between its predictions and the actual data points, resulting in highly accurate and coherent generative capabilities. For example, the systems 132-138 may be trained using human, agent-generated summaries that inform future-generated summaries by the systems 132-138.

Although various implementations describe the systems 132-138 as being large language models, it should be understood that the present techniques may be implemented in connection with any type of generative model. For example, the systems 132-138 may include large language models, multimodal generative models, stable diffusion models or other diffusion-based models, generative adversarial networks (GANs), variational autoencoder models, or any other type of generative model. In some implementations, such systems 132-138 may include additional output layers or may be otherwise configured to generate output values corresponding to the various scores described herein.

In some implementations, the systems 132-138 may include any number of input layers, hidden layers, and output layers. In some implementations, one or more systems 132-138 may be or include pre-trained generative models that are fine-tuned to specific applications. For example, the output of one or more of the systems 132-138 can be controlled and guided during a fine-tuning process by introducing task-specific loss functions or constraints, which can be utilized to optimize and specify particular application-specific outputs of the systems 132-138. In some implementations, one or more of the systems 132-138 may be trained using a fine-tuning process to automatically generate outputs corresponding to the one or more scores, which may be stored, for example, as part of score data or displayed via one or more graphical user interfaces (e.g., a graphical user interface of the user device 140).

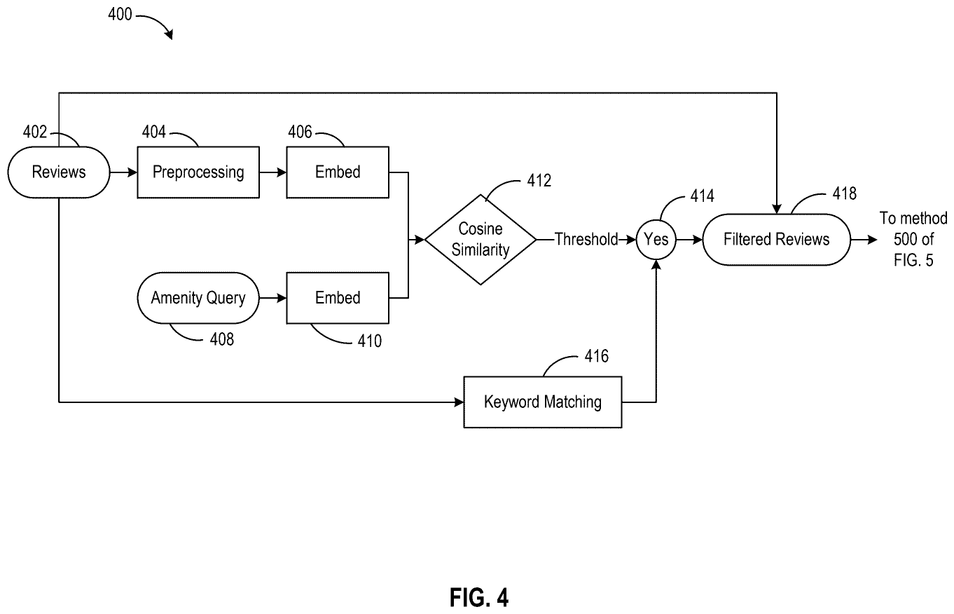

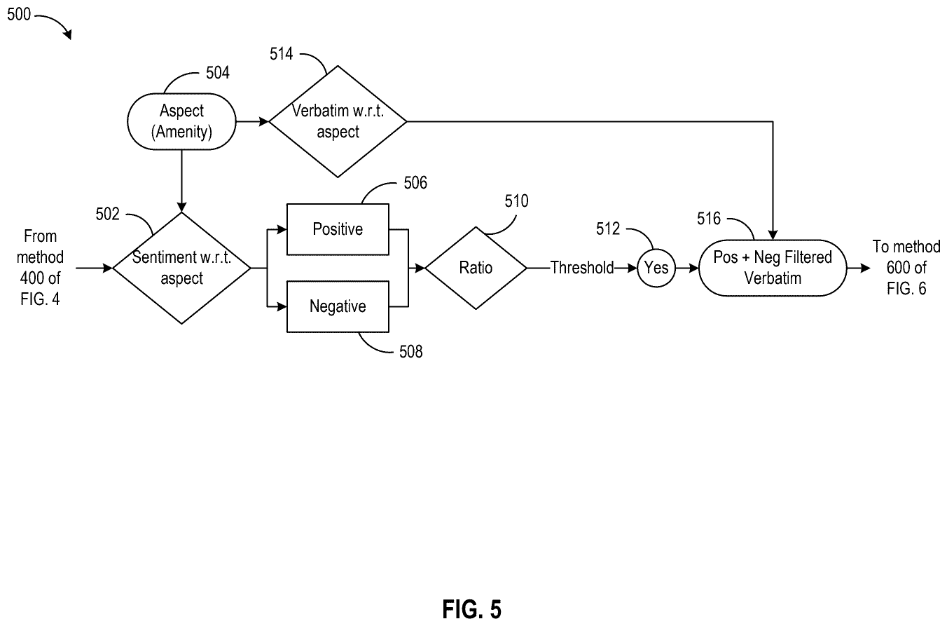

The retrieval system 132 may be configured to retrieve a plurality of reviews (e.g., content items) regarding an item of interest (e.g., an entity), such as a travel property, whereby the plurality of reviews are utilized to generate the summary. The retrieval system 132 may retrieve all or some predefined amount of reviews left for the property. In various embodiments, the retrieval system 132 may perform preprocessing on the raw retrieved reviews to filter the number and type of reviews used in generating the summary. For example, the retrieval system 132 may only utilize reviews written within a certain time period (e.g., within the last three years) and written in a certain language (e.g., English). In various embodiments, the content summarizer 130 may generate summaries for a specific unit (e.g., a specific hotel room or type of hotel room) of a property. As such, preprocessing the reviews may include filtering reviews such that only reviews mentioning the room or type of room are included in the filtered reviews used to generate the amenity and overall summaries. In this way, a filter may be used specific to room types (e.g., rooms with an ocean view versus rooms with a non-ocean view) such that summaries are specific to the specific room types. The retrieval system 132 will be described in greater detail with respect to FIG. 4.

The sentiment and extraction system 134 may extract a sentiment of each individual review (e.g., content item) retrieved by the retrieval system 132 that is to be utilized after preprocessing. The sentiment and extraction system 134 may analyze the raw review to determine a sentiment associated with the review. The sentiment and extraction system 134 may determine a set or list of topics or keywords upon which the summary is to be based. Each topic may correspond to an amenity or aspect (e.g., element) of the property being summarized. The set of topics may be predefined (e.g., a static list input by an agent) or dynamic (e.g., determined by the content summarizer 130 and changing for each user, property, etc.) and may be retrieved by the retrieval system 132 from a third party (e.g., third-party computing system 170). A predefined set of topics may be limited to a number of topics chosen by the human agent, while a dynamic set of topics may include any number of topics determined by the content summarizer 130. Using a predefined set of topics may limit the number of amenities or aspects to be summarized, thereby conserving processing power. Thus, reviews can be analyzed more quickly and content summarized can be generated more quickly, conserving processing power. Topics included in the set may include, for example, budget, parking, breakfast, pool, gym facilities, cleanliness, etc. In embodiments where a specific unit or type of unit is to be summarized, the topics may include, for example, coffee maker, bed comfortability, room size, room views, furniture, bathroom cleanliness, etc. The sentiment and extraction system 134 may then determine a sentiment for each aspect of the property (e.g., each topic) found in the review (e.g., for each reference to an element in the content item, a sentiment is determined). In one embodiment, the sentiment is a limited number of values or classes, such as two: positive or negative (or 1 and 0, where 1 is positive and 0 is negative). In other embodiments, more than two values or classes may be utilized. Application of the sentiment may be predefined, such as a sentence-by-sentence basis, phrase-by-phrase, etc. For example, in various embodiments, the sentiment may be determined on a scale whereby each sentence is assigned a value corresponding to how negative or how positive the statement is determined to be. Aspect-based sentiment analysis may provide specificity and improved generated summaries. In some embodiments, an overall sentiment of a review may be based on a number of characteristics (e.g., sentences, phrases, paragraphs, etc.) determined to have a positive sentiment and a negative sentiment (e.g., a review having a greater number of characteristics with positive sentiment compared to a number of characteristics with negative sentiment has an overall positive sentiment). In other embodiments, the overall sentiment of a review is determined using a different method. For example, an overall sentiment of a review may be determined to be negative based on three of five sentences being determined to be negative versus positive. However, the review may describe specific aspects or amenities of the property with a positive sentiment. By performing aspect-based sentiment analysis, neither positive nor negative sentiments may be omitted or missed during review analysis.

Further, in some embodiments, the sentiment and extraction system 134 may assign different weights to different reviews when determining the sentiment for a particular amenity (e.g., the sentiment and extraction system 134 weights each content item). Newer reviews may contain more accurate information than older reviews and may therefore more heavily affect the sentiment for the amenity. For example, weights for reviews may be assigned according to a decaying function as the review gets older (e.g., the post date ages relative to a current date). For example, when determining sentiment, a review posted one day ago may be assigned a higher value weight than the sentiment for a review posted more than X (e.g., 30) months ago relative to a current date (e.g., each content item is weighted based on an age of the content item).

In various embodiments, the sentiment and extraction system 134 analyzes textual or text-based reviews. For example, in one embodiment, a user leaving a review may type or otherwise write a review that is textual in nature. In another embodiment, the sentiment and extraction system 134 may receive a review left orally (e.g., spoken) and convert the review into text that can be analyzed. Upon determining the sentiment for each aspect of the property, the sentiment and extraction system 134 may extract corresponding text of the review. The extracted text may be sent to the summarization system 136 to be summarized. In one embodiment, the extracted text is verbatim from the review. In another embodiment, the sentiment and extraction system 134 extracts a predefined amount of text (something less than all) of the review. Sending extracted verbatim text to be summarized may ensure that irrelevant or unrelated details of the reviews are not summarized and may reduce a number of tokens being sent to the summarization LLM so that a greater number of reviews can be included for use in generating the summary.

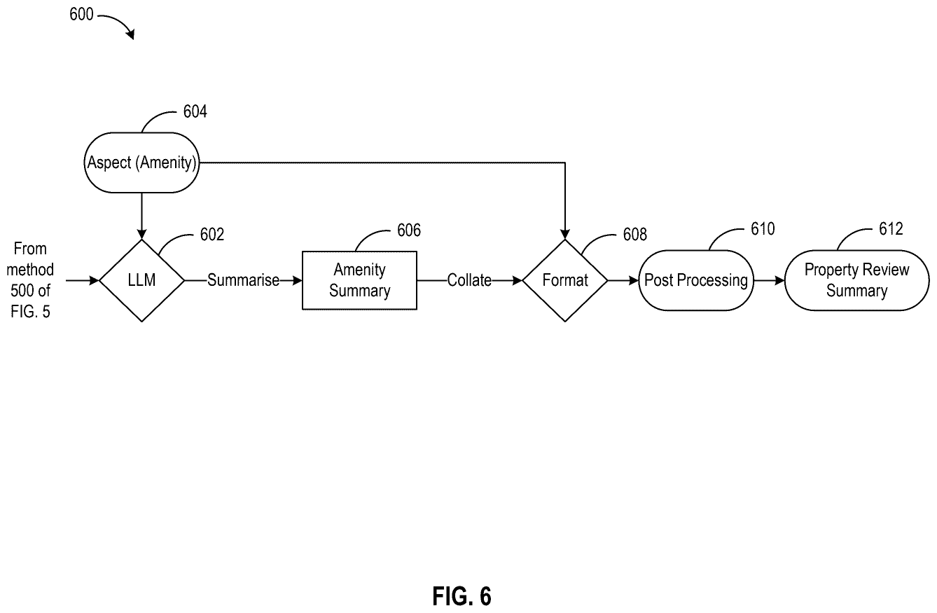

In various embodiments, the text may be extracted from one or more of the reviews prior to sentiment analysis. For example, the sentiment and extraction system 134 may identify text associated with each of the determined topics and extract the text. For each piece of extracted text, the sentiment and extraction system 134 may determine the corresponding sentiment. The sentiment and extraction system 134 will be described in greater detail with respect to FIG. 5.

The summarization system 136 may summarize the extracted text. Each topic (e.g., element referenced in a review or content item) may be summarized separately such that a separate summary is generated for each amenity indicated by each topic in the set of topics. The summarization system 136 may utilize the resulting summaries as amenity summaries and cause the amenity summaries to be displayed to a user via a GUI on the user device 140. For example, extracted verbatim text for the topic “pool” may state “the pool was heated and had plenty of space for us to swim.” The summarization system 136 may summarize the text to state: “Guests like the pool, mentioning it had ample space and was heated.” The summary may be displayed on a GUI of the user device 140 beneath a title indicating the topic (e.g., pool). In various embodiments, the amenity summaries may be relatively short compared to the generated summary for the entire property (e.g., a textual description between 1-3 sentences long). Extracted verbatim text for multiple topics may also be summarized to generate a longer summary for the entire property (e.g., a textual description that is 3-5 sentences, a paragraph, multiple paragraphs, etc.). In some embodiments, the generated amenity summaries may be used to generate the summary for the entire property.

The summarization system 136 may also be configured to personalize the generated amenity and overall summaries for different users. For example, the user may log into the client application 145 (e.g., an application associated with the provider or the provider computing system 105) of the user device 140 by providing credentials (e.g., a username and password) associated with a user account of the user for the client application. The provider computing system 105 may receive the user credentials and approve user access to the client application. Once approved, the provider computing system 105 may receive, from the user via inputs made to the user interface, information regarding searches, bookings, clicks, etc. made by the user and personalize content displayed to the user on the GUI.

For example, the amenities summarized and displayed on the user interface to the user may vary based on user preferences (e.g., the amenity summaries are displayed to a user based on one or more user preferences). Further, the tone, formatting, length, formality, etc. of the summary may be customized based on user preferences. In various embodiments, the user preferences are determined based on a user's clicks and interactions with the provider website (e.g., the summaries). For example, when the user is logged into their account associated with the provider computing system 105, the provider computing system 105 may monitor and track the user's search history, interactions with property listings, interactions with user reviews, interactions with generated summaries, etc. Each generated summary may include an icon or other method of allowing user feedback and interaction. For example, a user may be able to click on a “thumbs up” or “thumbs down” icon to indicate that the user likes or dislikes, respectively, the displayed summary. The summarization system 136 may use the user interactions to inform future summaries generated for the user when the user is logged into their account. For example, the summarization system 136 may receive user feedback indicating that a user may “like” summaries that include descriptions of the pool, the gym, and the spa at the property and summaries that are formatted in a paragraph of 5-6 sentences. The user may “dislike” summaries that are formatted in a bulleted list. The summarization system 136 may, for future generated summaries for the user, update the amenity summary to include amenity summaries for the pool, the gym, and the spa, and update and/or format the overall summary as a paragraph with 5-6 sentences to be displayed to the user, based on the user feedback. Additionally, in embodiments where the summaries are generated for a specific unit, the summarization system 136 may generate summaries for amenities found in a specific type of room determined to be, based on user preferences, the type of room the user has previously stayed in or prefers to stay in. For example, a refrigerator may only be available in hotel rooms designed as “suites.” The user preferences may indicate that the user stays or is likely to stay in a basic, non-suit room. Accordingly, the amenity summaries may not include summaries for a refrigerator.

In various embodiments, the summarization system 136 may customize the summaries for a user without the user logging into an account associated with the provider. For example, a user may visit the provider website via the user device 140 (e.g., via the client application 145) and view property summaries multiple times on the same browser and/or user device. The summarization system 136 may use cookies to predict what information the user prefers to see in the summaries. For example, the summarization system 136 may receive cookies, generated by the web browser on which the user is searching for properties, indicative of user interactions (e.g., clicks on reviews, properties generated summaries, etc.). For example, the summarization system 136 may receive, from the web browser, cookies that indicate that a user has clicked on amenity summaries relating to the cleanliness of the property and parking on the property. The summarization system 136 may generate and format subsequent amenity summaries and the overall summary such that they include descriptions of the cleanliness and parking on the property and display the customized summarizes to the specific user via the GUI on the user device 140.

Further, in various embodiments, the content summarizer 130 may receive user feedback from a plurality of groups of users to determine which types of summaries are preferred by different users (e.g., which types of summaries are preferred by the most users). For example, visitors to the provider website (e.g., both users that have logged into an account and users visiting the provider website without logging into an account) may be randomly bucketed and shown varying summaries. Based on user feedback, the summarization system 136 may build a preference model to determine what users like which types of summaries. For example, the provider website may be visited by 50,000 users at a given time. The provider computing system 105 may randomly sort the users into five groups of 10,000 users each. The summarization system 136 may, for each reviewed property, generate five variations of the amenity summaries and/or the overall summary and display a different variation to each of the five groups (e.g., having different tones, formats, lengths, amenities summarized, etc.). The provider computing system 105 may receive indications of user interactions with the summaries (e.g., clicks on summaries, “likes” or “dislikes” for summaries, etc.) to generate, by the summarization system 136, a user preference model. The summarization system 136 may use the user preference model to modify future generated summaries for various users.

Further, summary personalization may be specific to various groups. For example, a user may search for properties that can accommodate two adults and two children. The summarization system 136 may receive information relating to the user's search filters to generate summaries for the properties that include kid-friendly amenities such as pools, waterparks, family-friendly restaurants, family-friendly activities, etc. Alternatively, the summarization system 136 may generate, for a user searching for properties that can accommodate two adults, summaries that include restaurants, spas, etc. The summarization system 136 will be described in greater detail with respect to FIG. 6.

The post-processing system 138 may be structured or configured to process the generated amenity summaries for use in generating an overall summary generated for the item or entity (e.g., travel property). The post-processing system 138 may generate an overall summary, which is a textual description of the overall property and/or one or more amenities of the property, and populate the overall summary in a field of a graphical user interface displaying a property, information relating to the property, and user reviews left for the property. The overall summary may include summaries of a number of the most frequently referenced amenities in the user reviews. For example, the overall summary may include summaries of the top six referenced amenities. The post-processing system 138 may format the overall summary as a bulleted list, a paragraph, etc.

The post-processing system 138 may perform a validation, such as an attribute content store (ACS) validation, of the individual summaries before usage to generate the overall summary. Content validation may be performed by the post-processing system 138 to verify that the generated summary does not or likely does not contradict property policies, a current state of the property, etc. (e.g., verify that the first summary is accurate). The post-processing system 138 may store attributes of the property (e.g., parking, free breakfast, pool, in-unit laundry, etc.). The post-processing system 138 may check whether each attribute is compliant or likely compliant (e.g., accurate) with the actual property features. If an attribute is not or likely not compliant with the actual property feature, the review, the sentence of the review including the incorrect or inaccurate information, and/or the generated summary may be removed and/or updated. The post-processing system 138 may check whether the attribute is compliant or likely compliant by making an API call to a third party system 170 (e.g., a third party system 170 associated with the owner or host of the property being summarized). The API call may include a request for policy information associated with the property, current amenity information for the property, etc. The third party system 170 may transmit, to the post-processing system 138, the requested information responsive to the API call. For example, a review may indicate that parking was available for free at the property at the time the review was written. The post-processing system 138 may transmit an API call to the third party system 170 associated with the provider, the API call requesting information on the parking policy for the property. Responsive to receipt of the information, the post-processing system 138 may determine, based on the received information, that the property has updated their policies such that customers are now charged for parking. Including in the generated summary by the post-processing system 138 that parking is free at the property may cause misinformation. As such, while performing content validation, the post-processing system 138 may remove amenity summaries where the summarized reviews of the property indicate a conflict with the current policy of the property. For example, the post processing system 138 may remove extracted text and/or amenities where there is an indication that parking is free to avoid conflict with the current paid parking policy of the property.

In various embodiments, the system 100 may include an option for a user or third party to dispute a summary displayed on a website associated with the provider that controls, owns, manages, or is otherwise associated with the provider computing system 105. For example, an owner of a property may see, on the provider website, that a summary indicates parking is free, when parking is now paid at the property. The owner of the property can flag or otherwise dispute the summary and provide an explanation for the dispute (e.g., indicate in a comment box that parking is now paid). The system may receive the dispute and update the content summarizer 130 such that text indicating parking is free is no longer included in amenity summaries or overall summaries. For example, the user may provide, to the provider computing system 105, via the GUI of the client application 145, a message or indication that information included in the generated summaries and/or user reviews is outdated. The post-processing system 138 receives the message or indication and validates the message or indication by sending, to the third party computing system 170 associated with the property, a message indicating or confirming that the content is outdated and should be removed. Upon confirmation that the content is outdated (e.g., by the third party system 170 sending a confirmation back to the provider computing system 105), the post-processing system 138 may update the generated summaries to include the confirmed accurate information.

The post-processing system 138 may also perform toxicity checking. For example, some user reviews used in the generated summaries may include toxic content or language that is then included in the summaries. Toxic content may include content that is predefined in the post-processing system 138 to be not allowed (e.g., against policy). Toxic content may include, for example, expletives, overly negative language, overly positive language, exaggerations of the property, understatements of the property, etc. In some embodiments, toxic content may be classified as toxic content by training the model(s). For example, a training input may be a toxic review or summary that contains overly negative or positive language. The post-processing system 138 may be trained to recognize similar language in non-training data summaries as toxic and subsequently be able to identify such language as toxic when found in a real (e.g., not training data) summary. Toxicity checking may prevent the LLM from being biased and/or partial. The post-processing system 138 may store a list of predefined words and/or phrases that indicate toxicity. When the post-processing system 138 detects one or more of those predefined words and/or phrases, the post-processing system 138 defines that review as toxic and removes that review from being used to generate the overall summary. Further, in some embodiments, the toxic summaries may be used in training for the LLMs (e.g., the systems 132-138) so that the LLM does not include toxic language in future summaries. For example, toxicity checking may be performed and one or more summaries may be determined to include toxic content. The summaries may be removed from the GUI display, and the summaries may be used to train the post-processing system 138 to identify similar summaries as toxic so that future summaries do not include such toxic language.

Content validation, summary dispute, and toxicity checking may all be ways of causing the GUI to include summaries of an item (e.g., a property) that accurately reflect the state of the item or property being reviewed and summarized. For example, content validation and summary dispute ensure that the GUIs provide up-to-date information so that a user can make an as-informed as possible decision. Further, a negative review may be left by a user that had an abnormally negative experience such that the review does not accurately reflect the item. A summary that is based, in part, on the overly negative review may give the user an exaggerated perception of the item, causing the user to not purchase the item. Performing a toxicity check and removing the exaggerated review would give the user a more accurate perception of the item being summarized.

Similarly, toxicity checking may reduce bias in the LLMs of the systems 132-138, thereby providing summaries that are accurate reflections of experiences of a majority of reviewers.

In various embodiments, after post-processing the amenity summaries (e.g., performing content validation, toxicity checking, etc.), the amenity summaries may be combined to generate an overall summary by the post-processing system 138. The overall summary for the property may include multiple amenity summaries and/or additional content. Further, in various embodiments, the overall summaries may be generated by the post-processing system 138 in accordance with different user preferences, as described above with respect to the summarization system 136.

In various embodiments, the content summarizer 130 may analyze trends in generated summaries. The trends may refer to patterns or trends determined from the analyzed reviews and/or generated summaries. For example, the content summarizer 130 may determine that, for a specific amenity at a property, the sentiment has gone from positive to negative over the past predefined time period (e.g., one or more changes in sentiment for a particular amenity have occurred). The content summarizer 130 may determine, based on the reviews and generated summaries, what specific aspects of the amenity have changed or caused the sentiment to change. These determinations may be communicated, by the content summarizer 130, to a third party system 170 associated with a host or owner of the property, via the network 101, to provide notifications, insights and/or potential recommendations to the host or owner to improve their property. For example, the content summarizer 130 may determine, based on trends in review sentiment and generated summaries, that a property's sentiment for bathroom cleanliness has gone from positive to negative. Specifically, the content summarizer 130 may determine that dirty sinks and countertops were not previously mentioned but now are mentioned, and are contributing to negative sentiments in reviews. This information determined by the content summarizer 130 may be communicated to an owner of the property, who may use the information to improve cleaning in the bathrooms of the property and potentially improve the sentiment for bathroom cleanliness in reviews.

Further, for multiple properties (e.g., multiple properties owned by the same person, multiple properties in a certain area, etc.), the content summarizer 130 may use the generated summaries to provide comparisons of the properties and provide the comparisons to the user via a GUI of the client application 145 for aid in selecting a property. For example, three properties may be within a two mile radius of each other. The content summarizer 130 may present a comparison of all three properties by displaying one or more of the generated summaries that the user can view to determine which property they may book. Further, a user may be able to select properties to compare.

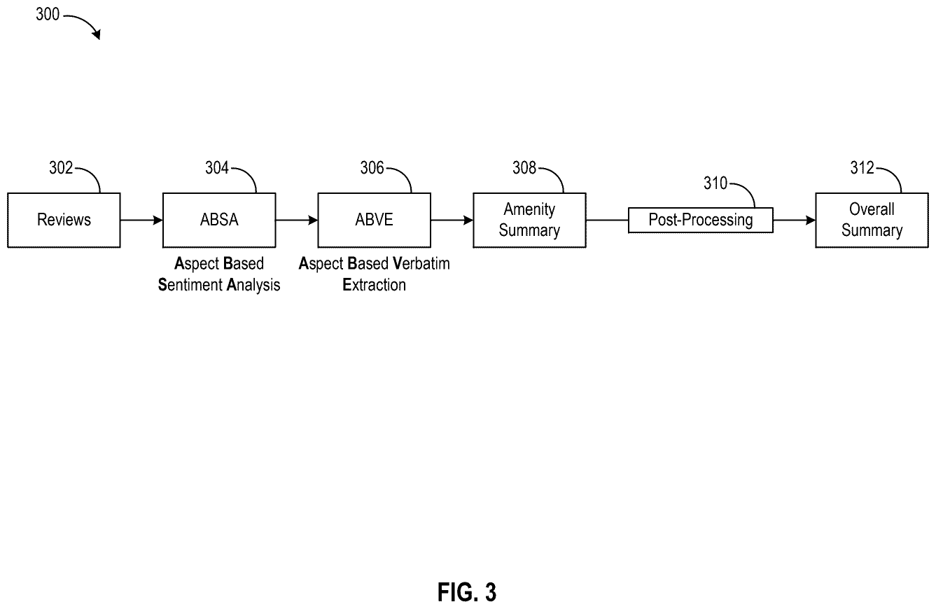

Referring now to FIG. 3, a flow diagram of a method 300 of summarizing property reviews is shown, according to an example embodiment.

At process 302, the retrieval system 132 retrieves content (e.g., reviews) from a plurality of user content items for an item (e.g., a rental property). The user content may be located on and retrieved from an application associated with the provider computing system 105, and the item may be rented or sold by a third party associated with the third party system 170. At process 304, the sentiment and extraction system 134 performs aspect-based sentiment analysis for each of the plurality of user content items. Specifically, for each determined topic within each content item that the sentiment and extraction system 134 determines will be summarized, the sentiment and extraction system 134 determines a sentiment relating to that topic for each content item in which the topic is mentioned. At process 306, the sentiment and extraction system 134 performs aspect-based verbatim extraction. Specifically, for each topic identified in the content item, the sentiment and extraction system 134 extracts the text describing that topic for use at process 308 to generate a summary of an aspect (e.g., an amenity) corresponding to the topic. Thus, at process 308, the summarization system 136 generates one or more amenity summaries for each aspect or amenity identified in each content item by the sentiment and extraction system 134. At process 310, the post-processing system 138 performs post-processing on each of the amenity summaries. For example, the post-processing system 138 performs content validation and toxicity checking. At process 312, the post-processing system 138 aggregates and/or otherwise combines the post-processed amenity summaries and generates an overall summary for the property. Further, the post-processing system 138 and/or another component of the content summarizer 130 may transmit the amenity summaries and/or overall summary to the client application 145. The provider computing system 105 may cause the summaries to be displayed on a GUI of the client application 145 of the user device 140.

Referring now to FIG. 4, a flowchart of a method 400 for selecting content items for summarizing content items is shown, according to an example embodiment. In some embodiments, the method 400 may be a method for selecting reviews for summarizing property reviews. The method 400 may be performed by the retrieval system 132 described with respect to FIG. 2.

At process 402, the retrieval system 132 retrieves content items associated with a particular item or service on a website of the provider computing system 105. Specifically, the retrieval system 132 retrieves user reviews associated with a particular property from a website associated with the provider computing system 105. The retrieval system 132 may retrieve all of the reviews left for the property.

At process 404, the retrieval system 132 preprocesses the content items. For example, the retrieval system 132 preprocessed the retrieved user reviews. Preprocessing may include, for example, filtering the reviews such that only reviews written in a specific language (e.g., English) and posted within a certain timeframe (e.g., within three years) are used by the content summarizer 130 to generate the summaries. In various embodiments, the content summarizer 130 may be configured to generate amenity and overall summaries for a unit of a property, such as a hotel room or specific apartment unit. In such embodiments, preprocessing may include filtering the reviews such that only reviews including a description of the unit to be summarized are utilized by the content summarizer 130.

At process 406, the retrieval system 132 embeds the preprocessed content items. For example, the retrieval system 132 embeds the preprocessed reviews by converting the text in the reviews into another format (e.g., numbers, vectors, etc.) that can be processed by the LLM (e.g., the retrieval system 132) so that the LLMs (e.g., the systems 132-138) can summarize the reviews.

At process 408, the retrieval system 132 makes a query to determine items, such as amenities of a property, to be summarized. For example, the retrieval system 132 makes a query to the third party system 170 associated with the property to retrieve a list of amenities offered by or available at the property. The retrieval system 132 may add to or remove from list of amenities such that the list include amenities that are determined, by the retrieval system 132, to be frequently mentioned in property reviews. In some embodiments, the list may be predetermined (e.g., manually determined by a human agent). In some embodiments, the list may be dynamically generated based on, for example, previous reviews left that inform the retrieval system 132 regarding popular or frequently-reviewed amenities.

At process 410, the retrieval system 132 embeds the list of items retrieved at process 408. Embedding may include converting, by the retrieval system 132, a textual list of amenities to summarize into a format (e.g., number, vector) that can be processed by the content summarizer 130.

At process 412, the retrieval system 132 performs a similarity determination process. The similarity determination may quantify the similarity between two objects, in this case the embedded content items (e.g., property reviews) and the embedded list of items (e.g., the list of amenities of the property) As a particular example, the retrieval system 132 performs a cosine similarity between the embedded reviews and the embedded amenity query. In some embodiments, the retrieval system 132 performs another similarity determination process, such as Manhattan distance, Euclidean distance, Minkowski distance, Chebyshev distance, etc. The retrieval system 132 may perform the similarity determination process (e.g., cosine similarity) for each review. Calculating the similarity between the review and the amenity query may allow the retrieval system 132 to determine that a certain review is relevant and should be included for generation of the summary. The retrieval system 132 may determine the similarity using cosine similarity between the vector resulting from the embedding of the review and the vector resulting from the embedding of the amenity query. The result may be a cosine similarity value and may be expressed as a decimal, fraction, percent, etc. A cosine similarity value may be determined for every preprocessed review.

At process 414, the retrieval system 132 determines whether the determined cosine similarity value is greater than or equal to a predetermined threshold value. The similarity being greater than or equal to the threshold value may indicate that the review includes a certain amount of information (e.g., text, description, etc.) that describes, addresses, and/or is relevant to one or more amenities returned in the query made at process 408. For example, the query made at process 408 may return a list of amenities including a pool, a spa, free parking, and free breakfast. The retrieval system 132 determines how much overlap exists between an embedded (e.g., vectorized, etc.) review and the embedded (e.g., vectorized) list of amenities. The similarity being greater than or equal to the threshold value may indicate that, the review discusses, mentions, etc. one or more of the amenities in the list of amenities to be summarized (e.g., one or more of the pool, the spa, the free parking, and/or the free breakfast). The threshold value may be set to a certain value (e.g., 0.5, 0.6, 0.65, etc.). A lower threshold value may cause more reviews to be included in the summarization process since the review may have fewer similarities (e.g., mentions) to the amenities in the amenity query. A lower threshold value may provide the content summarizer 130 with a greater amount of data to produce a more robust summary, but the summary may be less relevant to the user. A higher threshold value may provide the content summarizer 130 with more relevant data, but fewer reviews to base the data on, so the summaries may be less detailed or robust. Responsive to a determination by the retrieval system 132 that the cosine similarity value is greater than or equal to the threshold value, the method 400 continues to process 418. Responsive to a determination by the retrieval system 132 that the cosine similarity value for a review is less than the threshold value, the review is determined to be neutral or irrelevant and is discarded (e.g., is not used to generate the summaries).

At process 416, the retrieval system 132 performs a matching process. In particular, the retrieval system 132 may perform a keyword matching process. Process 416 may be before, concurrently, or subsequent to process 412 and/or process 414. Keyword matching may include matching generated keywords to words in the reviews. The retrieval system 132 may generate the keywords based on the text in the reviews, amenities offered by the property, etc. In some embodiments, the retrieval system 132 may generate, in addition or alternative to keywords, key phrases, key sentences, etc. Keyword matching may aid in comparing the reviews to the amenities when embeddings do not work well. For example, nuanced amenities (e.g., “all-inclusive”) may be difficult to embed, and keyword matching may ensure that the nuanced amenities are considered. Thus, keyword matching provides an additional method of ensuring relevant reviews are used in summarization. For example, relying only on embeddings to determine whether a review is relevant or not may cause certain reviews to be overlooked, because the amenities in the list of amenities generated at 408 do not easily translate into an embedded (e.g., vectorized) format. Thus, the similarity value may appear to be lower than it actually is, because a nuanced (e.g., not easily embedded) amenity is not seen as being described in the review. Keyword matching ensures that these amenities are compared to the review and contribute to determining the relevance of the review.

At process 418, the retrieval system 132 produces filtered content items for use in generating the item-specific and overall property summaries. For example, the retrieval system 132 produces filtered reviews for use in generating the amenity and overall property summaries. After the filtered reviews are determined, the method 400 continues to the method 500, which will be described with respect to FIG. 5.

Referring now to FIG. 5, a flowchart of a method 500 for sentiment analysis and extraction for summarizing content items is shown, according to an example embodiment. In some embodiments, the method 500 is a method for sentiment analysis and extraction for summarizing property reviews. In some embodiments, the method 500 may include verbatim extraction for summarizing property reviews. The method 500 may be performed by the sentiment and extraction system 134 described with respect to FIG. 2. The method 500 may be performed after the processes 402-418 of the method 400 are completed.

At process 502, the sentiment and extraction system 134 determines sentiment for one or more characteristics of each of the filtered content items (e.g., reviews). A characteristic of the content item may be a word, a combination of words, a phrase a sentence, etc. The sentiment and extraction system 134 utilizes aspects (e.g., amenities from the amenity query made at process 408), shown as aspects 504, to determine the sentiment of each phrase in the review that corresponds to each amenity found in the review and the list of amenities. The sentiment may be determined on a per-amenity basis. The amenities for which the sentiments are determined may be the amenities in the list of amenities retrieved by the retrieval system 132 at process 408. Process 506 indicates sentiments for each amenity in the review text that have been classified, at process 502, as positive. Process 508 indicates sentiments for each amenity in the review text that have been classified, at process 502, as negative.

At process 510, the sentiment and extraction system 134 determines, for each item (e.g., amenity) included in the list of items (e.g., the list of amenities) retrieved at process 408, a ratio between the amount of positive sentiments determined for the item (e.g., amenity) and a total amount of sentiments determined for the item (e.g., amenity) across all of the content items (e.g., reviews) mentioning the item (e.g., the amenity). For example, 1000 reviews for a property may include a description of a pool. Eight hundred of the reviews may be determined, at process 502, to have a positive sentiment regarding the pool, and two hundred of the reviews may be determined, at process 502, to have a negative sentiment regarding the pool. The sentiment and extraction system 134 may determine a ratio of the number of positive sentiments to the number of total sentiments (i.e., eight hundred positive sentiments/1000 total sentiments=0.8) and a ratio of the number of negative sentiments to the number of total sentiments (i.e., two hundred negative sentiments/1000 total sentiments=0.2).

At process 512, the sentiment and extraction system 134 determines whether the ratio determined at process 510 is at or above a predefined threshold value. Responsive to a determination by the sentiment and extraction system 134 that the ratio is greater than or equal to the threshold value, the determined sentiment and reviews including a description of the amenity matching the determined sentiment are used, and the method 500 continues to process 516. The threshold value may be expressed as a decimal, fraction, percentage, etc. In various embodiments, the threshold value may be, for example, 0.65, 0.7, 0.75, etc. For example, the threshold value may be 0.7. Using the example above, the positive ratio for the pool is 0.8 and the negative ratio for the pool is 0.2. At process 512, the sentiment and extraction system 134 determines that the positive ratio is greater than 0.7 and the negative ratio is less than 0.7. As such, the determined positive sentiment and all of the reviews determined to describe the pool with a positive sentiment are used in summarization generation (e.g., in the method 600). The determined negative sentiment and the reviews describing the pool with a negative sentiment are discarded and not used in summary generation.

At process 514, the sentiment and extraction system 134 extracts text from the content item (e.g., review) with respect to the identified aspects of the content item (e.g., review). In some embodiments, the sentiment and extraction system 134 extracts text verbatim from the review. In other embodiments, the sentiment and extraction system 134 extracts paraphrased text from the review. For example, the sentiment and extraction system 134 identifies portions of the review that discuss each amenity. At process 514, the sentiment and extraction system 134 extracts each portion of text corresponding to the different aspects. In some embodiments, verbatim extraction may be used to extract, for each amenity, only relevant text with respect to the amenity/topic that is summarized. Verbatim extraction may reduce hallucinations and/or irrelevant data in the generated summaries. A hallucination may be information or details that were not present in the original prompt or training data of the LLM (e.g., the sentiment and extraction system 134) or are inconsistent with logical reasoning or reality. Because hallucinations may occur when the LLM uses a learned understanding of language and context to fill in gaps or make assumptions in the generated summaries, utilizing verbatim text reduces a likelihood or occurrence of the sentiment and extraction system 134 making assumptions and subsequent hallucinations.

At process 516, the sentiment and extraction system 134 generates and/or stores, for each item (e.g., amenity), filtered text (e.g., verbatim text) from each of the content items (e.g., reviews) that describes the item (e.g., amenity) with the sentiment determined at process 512. Continuing the example above, the sentiment and extraction system 134 stores extracted verbatim text from each of the eight hundred reviews that were determined to have described the pool with a positive sentiment. The extracted verbatim text and sentiment for each amenity is used in the method 600 of FIG. 6.

Referring now to FIG. 6, a flowchart of a method 600 for summarization of content items is shown, according to an example embodiment. In some embodiments, the method 600 may be a method for summarizing property reviews. The method 600 may be performed by the summarization system 136 and/or the post-processing system 138 described with respect to FIG. 2.

At process 602, the summarization system 136 inputs the filtered text (e.g., verbatim text) with positive and negative sentiment, generated/stored at process 516, into an LLM. The aspects (e.g., amenities) of the property determined by the retrieval system 132 at process 408, shown as amenities 604, are also input to the LLM at process 602. At process 602, the summarization system 136 generates an item (e.g., amenity) summary for each of the items (e.g., amenities) based on the extracted text for that item (e.g., amenity) and outputs the summary, shown as amenity summary 606. For example, an amenity summary for the pool of the property is generated by the summarization system 136 using the verbatim text extracted by the sentiment and extraction system 134 from each of the eight hundred reviews that described the pool with a positive sentiment. The amenity summary 606 may be a short (e.g., one sentence, few words, etc.) summary of the amenity. In various embodiments, for one amenity, at process 602, the LLM may generate multiple summaries 606, each describing a different aspect of the amenity. For example, a first amenity summary may describe that guests liked that the pool is heated, while a second amenity summary may describe that guests though that the pool was spacious.

At process 608, the summarization system 136 collates and formats the multiple item (e.g., amenity) summaries generated for each item (e.g., amenity). For example, three amenity summaries may be generated for an amenity. The summarization system 136 may collate and format all three amenity summaries. For example, the amenity summaries may be formatted into a bulleted list, a paragraph, etc. For example, at process 608, the amenity summary stating that the pool is heated may be collated and formatted with the second amenity summary stating that the pool was spacious. The amenity summaries may be formatted according to an allotted amount of space within the GUI. For example, the GUI displaying the summaries may include a plurality of elements (e.g., photos, descriptions, etc.) such that space designated for content summaries is limited, and a user may have to scroll or view a second page to view descriptions or reviews of the property. By aggregating the potentially large (e.g., hundreds, thousands, etc.) number of user reviews and formatting the content of the reviews into one smaller summary, the GUI can better accommodate the content and the user may view the information more easily. Further, the summarization system 136 may format the summaries based on user preferences. For example, different users may see different summaries for the same property or amenity based on their preferences. For example, a first user may see an amenity summary highlighting that parking on the property is free, while a second user may see an amenity summary highlighting that parking on the property is ample. Further, one user may view four amenity summaries for a pool, a gym, cleanliness, and breakfast, while a second user may view three amenity summaries for parking, a gym, and laundry. Further, the tone, length, writing style, etc. may be formatted differently for different users.

At process 610, the post-processing system 138 performs post-processing on each of the generated item (e.g., amenity) summaries. For example, the post-processing system 138 may perform content validation and toxicity checking for each amenity summary. During post-processing, the post-processing system 138 may also remove reviews, amenity summaries, etc. responsive to receiving an indication (e.g., from a user) that a summary or review contained outdated information. In various embodiments, the post-processing system 138 may perform post-processing on individual reviews for an amenity prior to the amenity review being generated. For example, at process 512, an amenity may be determined to have a negative sentiment based on the reviews. Prior to generation of the amenity summaries 606, the extracted verbatim text used to determine the negative sentiment for the amenity may be analyzed for toxicity checking. The post-processing system 138 may analyze the extracted verbatim text to determine any verbatim text that is toxic or overly negative. The toxic review may be omitted from use in generating the amenity summaries 606. Further, in some embodiments, post-processing may occur for the generated summaries. For example, a generated amenity summary may include toxic content because reviews used to generate the summary included toxic content. The post-processing system 138 may remove the amenity summary. For example, two amenity summaries may be generated for a free breakfast amenity that was determined to have a negative sentiment. The first amenity summary may include toxic content and the second amenity summary may not. The post-processing system 138 may remove the first amenity summary so that the first amenity summary is not displayed to the user, and only the second amenity summary is displayed to the user.

In various embodiments, the post-processing system 138 may determine that all reviews having the determined sentiment include toxic content. The post-processing system 138 may not generate a summary for the aspect since no reviews can be used. Further, because the sentiment was determined to be negative (e.g., at process 512), no amenity summary having a positive sentiment can be generated.

At process 612, the post-processing system 138 generates an overall property review summary using the generated amenity summaries. In various embodiments, the post-processing system 138 may further format and/or personalize the overall summary based on user preferences.

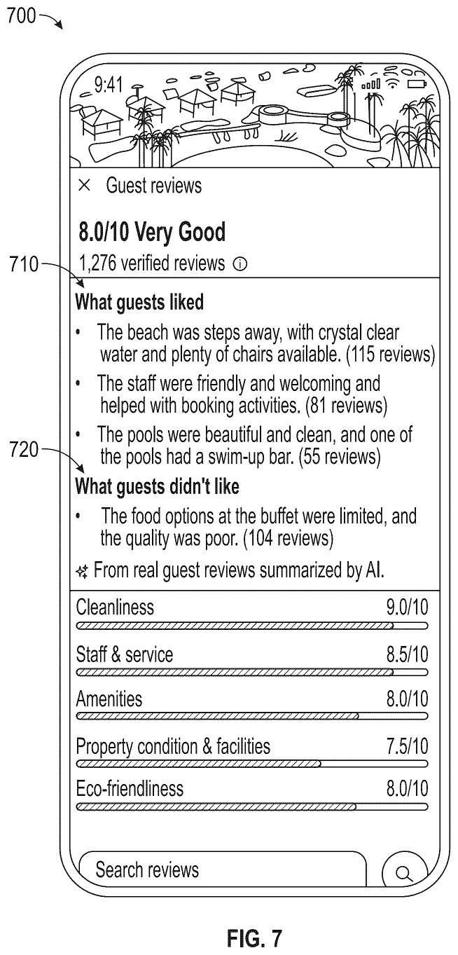

FIGS. 7-19, which will be described below, illustrate example user interfaces (UIs) and elements of user interfaces upon which the generated summaries are displayed. The user interfaces may be generated by the content summarizer 130 and transmitted, by the content summarizer 130, to the user device 140 for display on a user interface of the user device 140. In some embodiments, the generated user interfaces may be transmitted to and displayed by the client application 145. In other embodiments, the generated user interfaces may be transmitted to and displayed by a web page provided by the provider computing system 105. The UIs described with respect to FIGS. 7-19 may include similar elements and/or features. It should be understood that one or more of the user interfaces that will be described herein may be displayed on a user device 140 of a user. Further, the user of the user device 140 may customize a view and select a preferred user interface display.

The generated content summaries may provide multiple technical advantages. For example, providing summaries of a plurality of reviews may improve the appearance of the GUI by reducing a number of elements that the user views. Reducing a number of elements viewed by a user may make it easier for the user to view and synthesize information and ultimately make a decision about whether or not to book a property. Additionally, providing a GUI with summarized reviews rather than a plurality of reviews may allow more free space on the GUI. The GUI may then be able to have additional relevant elements or features displayed to a user, thus improving a user experience with the GUI.

Referring now to FIG. 7, a user interface (UI) 700 is shown, according to an example embodiment. The UI 700 displays generated summaries 710 and 720 that are generated by the content summarizer 130 (e.g., the summarization system 136 and/or the post-processing system 138). Specifically, each of the summaries 710 and 720 may be overall summaries of the property being reviewed/summarized. The content summarizer 130 may format the generated summary 710 as a bulleted list, organized based on amenity, of aspects of the property that users liked. The content summarizer 130 may generate the summary 710 such that the summary includes aspects of analyzed reviews determined (e.g., by the sentiment and extraction system 134) to have positive sentiment. The content summarizer 130 may generate and/or format the summary 720 to include a bulleted list of aspects of the property that users disliked. That is, the generated summary 720 may include aspects of analyzed reviews determined (e.g., by the sentiment and extraction system 134) to have negative sentiment. In various embodiments, the UI 700 may be a pop-up or overlay that is selectable by a user. In other embodiments, the UI 700 may be viewed within a main a viewing window.

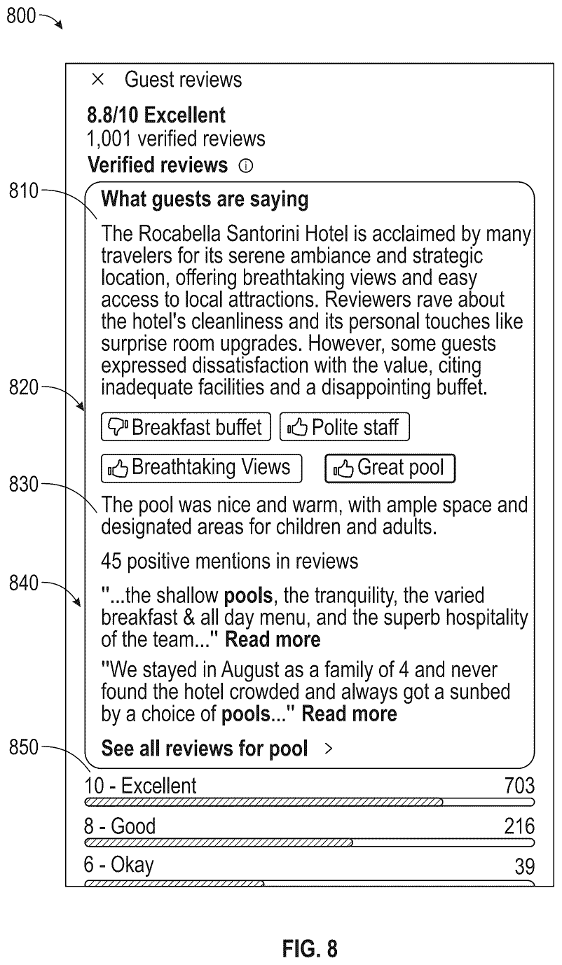

Referring now to FIG. 8, a user interface (UI) 800 is shown, according to an example embodiment. The UI 800 includes an overall summary 810 generated by the post-processing system 138. As shown in FIG. 8, the post-processing system 13 formats the overall summary 810 as a paragraph. The user UI 800 further includes amenity icons 820. The post-processing system 138 may generate amenity icons 820 that correspond to amenities of the property that are most mentioned in the user reviews used to generate the overall summary 810 and the amenity summaries for the property. For example, the amenity icons 820 may be generated according to the list of amenities retrieved by the retrieval system 132 that are offered by the property. Icons 820 may include an indicator of the determined sentiment of the corresponding amenity. For example, the great pool icon may include a thumbs up icon based on a determination that the overall user sentiment in the reviews mentioning the pool is positive. Each of the amenity icons 820 may be selectable by a user. For example, the user may select the “great pool” icon 820. Upon selecting a specific icon 820, the summarization system 136 may receive an indication of the user selection and generate an amenity summary 830 for the selected icon. The amenity summary 830 generated by the summarization system 136 may include a one sentence summary of the amenity and an indication of a number of reviews that mention the amenity according to the indicated sentiment. For example, the pool icon includes a thumbs up, indicating an overall positive determined sentiment, and the amenity summary 830 indicates a number of reviews that mention the pool positively. Upon selecting a specific icon 820, the content summarizer 130 may generate the UI 800 to further include a plurality of individual reviews 840. The displayed reviews 840 may be reviews that mention the amenity corresponding to the selected icon 820. The reviews 840 may include excerpts of the reviews that specifically mention the amenity. For example, the post-processing system 138 may use the retrieved, filtered reviews and cause the reviews to be displayed on the UI 800. Responsive to an indication (e.g., a click on a review 840) by the user to view the entire review, the content summarizer 130 may cause the entirety of the review 840 to be displayed on the UI 800. Further, the user may be able to select an option to read all reviews left for the property. The UI 800 may also include an indication 850 of a number of people that have rated the property a certain value. For example, users that leave reviews may be able to rate the property out of a number (e.g., out of 10). The UI 800 may display a number of ratings for each number.

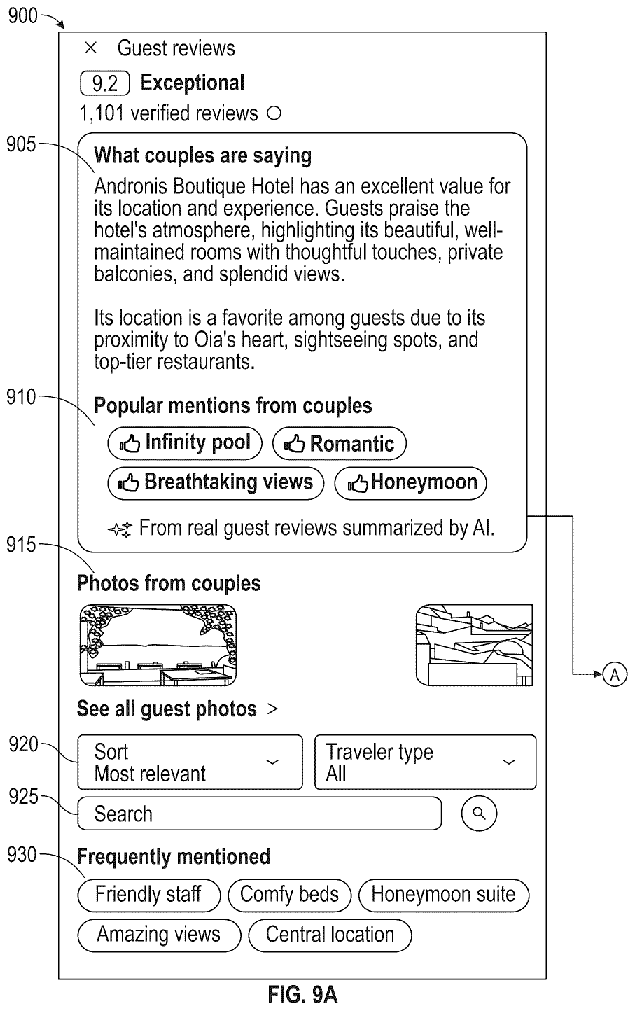

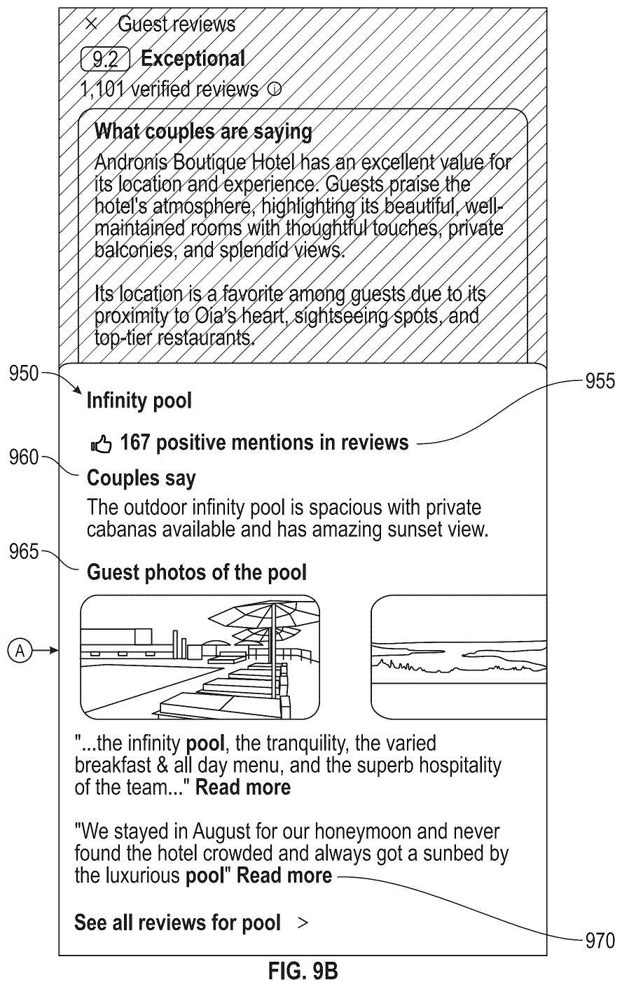

Referring now to FIGS. 9A and 9B, user interfaces (UIs) 900 and 950 are shown, according to an example embodiment. As shown in FIG. 9A, the content summarizer 130 may cause the UI 900 to be displayed when the content summarizer received, from the user, an indication (e.g., a selection or click on the user interface) to view reviews for a particular property. The UI 900 may include an overall summary 905 that is generated by the content summarizer 130. The content summarizer 130 may cause popular mention icons 910 to be displayed on the UI 900. The popular mention icons 910 may be indicative of the most commonly reviewed amenities of the property and their corresponding determined sentiments. The UI 900 may also include a plurality of photos 915 that reviewers of the property can upload, via, for example, the client application 145, when leaving a review. The UI 900 may include filters 920 that allow a user to filter through individual reviews left for the property. For example, upon receiving an indication from a user, the content summarizer 130 may cause the reviews to be sorted (e.g., by most relevant, highest rated, lowest rated, etc.) and/or filtered by traveler type (e.g., family, solo, couple, etc.). The UI 900 may also include a search bar 925 to search through individual reviews. For example, the user can enter a specific keyword to the search bar 925, and, upon receipt of an indication of the search, the content summarizer 130 may cause only reviews containing the keyword to be displayed. The UI 900 further includes frequently mentioned icons 930. The icons 930 may correspond to amenities or aspects of the property frequently mentioned in the individual reviews and may be generated and caused to be displayed on the UI 900 by the content summarizer 130. The user may select an icon 930 to view only individual reviews that mention the selected amenity or aspect.

Upon receipt, by the content summarizer 130, of a user selecting a popular mention icon 910, the content summarizer 130 may generate a second UI 950, shown in FIG. 9B, and may cause the UI 950 to be displayed on the user device 140. The UI 950 may be an overlay or popup display over the UI 900. The UI 950 may display more detailed information relating to the amenity indicated by the selected icon 910. For example as shown in FIG. 9, the user may select the “infinity pool” icon 910, and, upon receipt of the selection by the content summarizer 130, the UI 950 may be generated by the content summarizer 130 on the user device 140 to display information about the infinity pool. The UI 950 may indicate, at element 955, a number of reviews that have mentioned the amenity in a manner consistent with the determined sentiment. For example, the sentiment and extraction system 134 may determine that the sentiment for the infinity pool of the property is positive. The element 955 may indicate the number of reviews that positively mention the infinity pool. The summarization system 136 may generate an amenity summary 960 to be included in the UI 950. The amenity summary 960 may be generated by the summarization system 136, and may be a one sentence summary of the mentions of the amenity in the individual reviews. The UI 950 may also include photos 965 of the amenity that can be uploaded by reviewers via the client application 145. The UI 950 may further include a plurality of reviews 970. The reviews 970 may be reviews that mention the specific amenity being displayed on the UI 950 (e.g., reviews retrieved by the retrieval system 132). The user viewing the reviews may select an option to read the entire review and/or all reviews mentioning the amenity and, upon receipt of the selection, the content summarizer 130 may cause the entire review to be displayed.

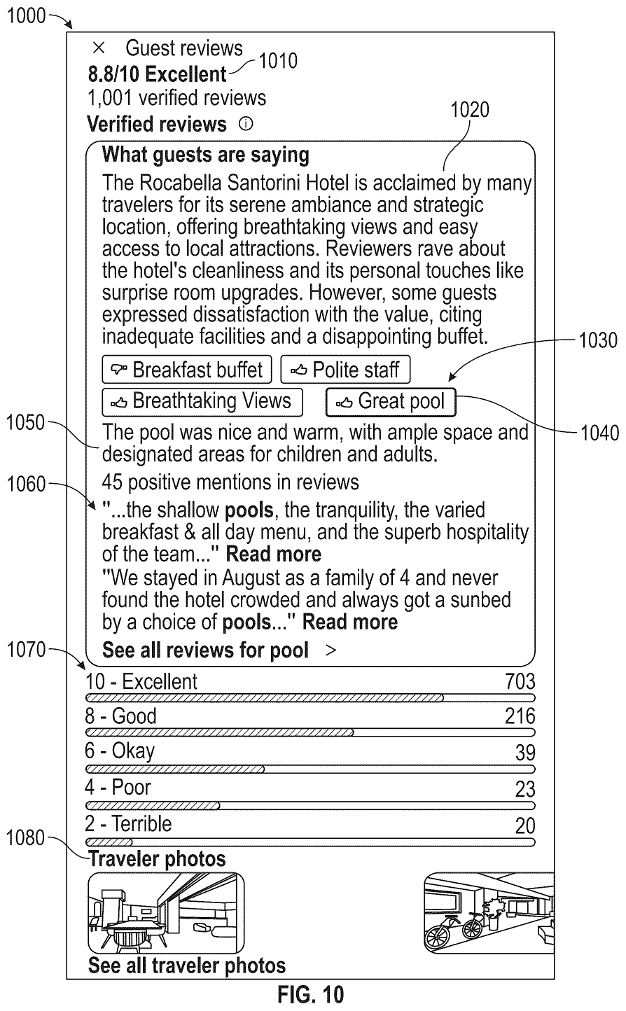

Referring now to FIG. 10, a user interface (UI) 1000 is shown, according to an example embodiment. The UI 1000 may be similar to the UI 800 described with respect to FIG. 8. For example, the content summarizer 130 may generate the UI 1000 that may include an overall summary 1020, amenity icons 1030, amenity summaries 1050, displayed reviews 1060, and an indication 1070 of a number of people that have rated the property a certain value. The UI 1000 may further include an average rating 1010, indicating an average of the user ratings indicated at 1070. The UI 1000 may also include user photos 1080 that may be uploaded by reviewers that have visited the property and/or owners or others associated with the property. The UI 1000 may further highlight an amenity icon 1030 (e.g., selected icon 1040) when an amenity has been selected to view further information (e.g., an amenity summary).

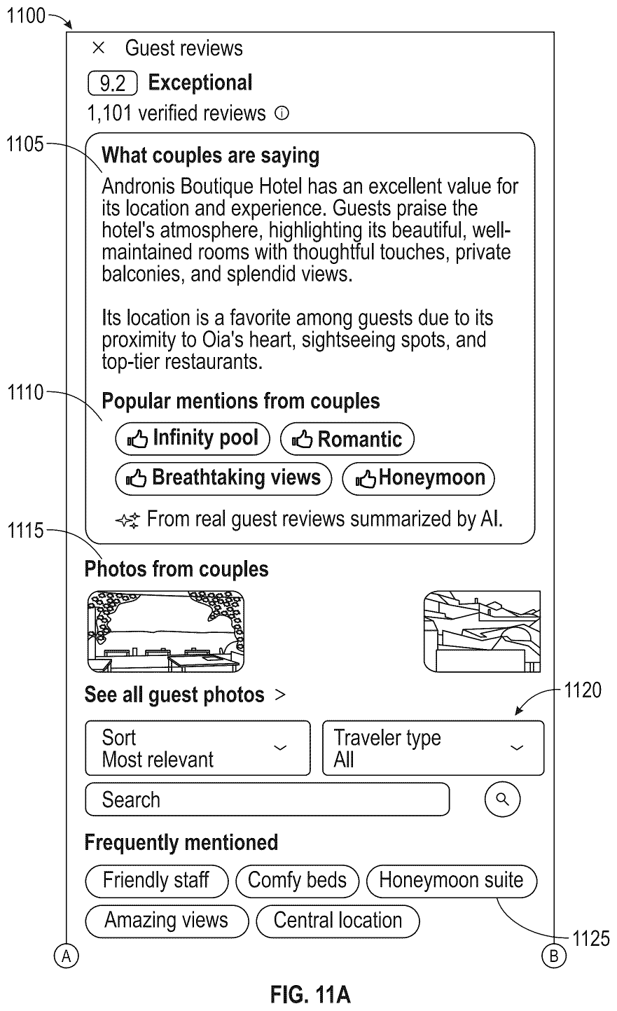

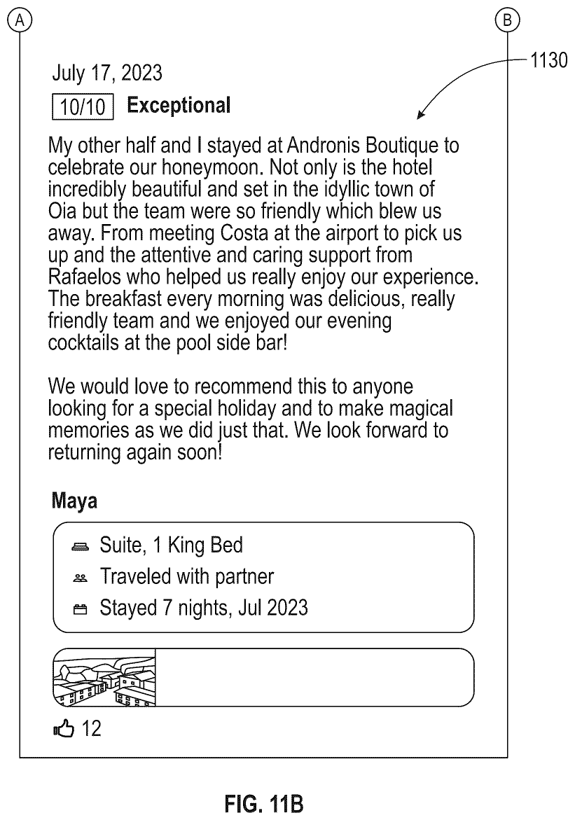

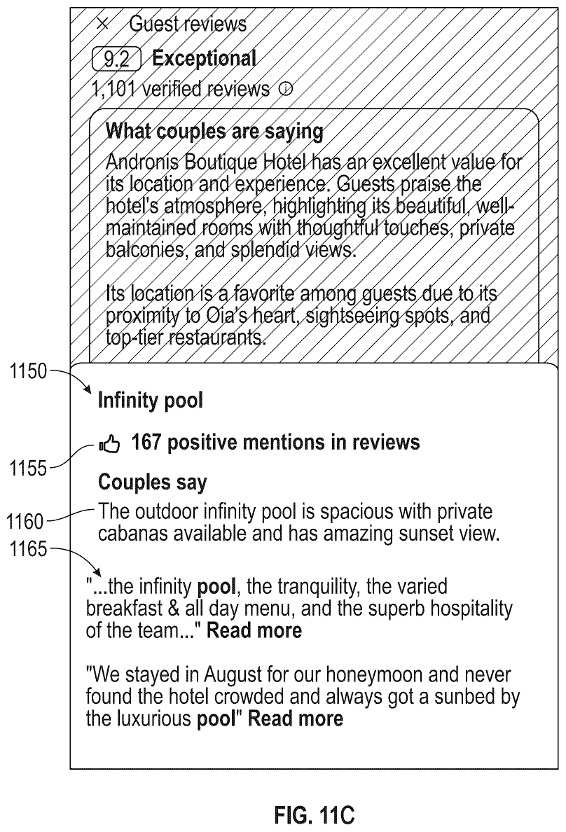

Referring now to FIGS. 11A and 11B, a user interface (UI) 1100 is shown, according to an example embodiment. FIG. 11A shows a first portion of the UI 1100 and FIG. 11B shows a second portion of the UI 1100 (e.g., FIG. 11B shows a lower or “scrolled down” portion of the UI 1100). The UI 1100 may be similar to the UI 900 shown in FIG. 9A. For example, the content summarizer 130 may generate the UI 1100 that may include an overall summary 1105, amenity icons 1110, user photos 1115, filters 1120, and frequently mentioned icons 1125, which may be similar to corresponding elements described with respect to FIG. 9. The UI 1100 may further include reviews 1130, shown in FIG. 11B. The reviews 1130 may be reviews left by individual users. The reviews 1130 displayed on the UI 1100 may be filtered using the filters 1120 and/or the icons 1125. Upon selection of an amenity icon 1110, a second UI 1150 may be generated, as shown in FIG. 11C. The UI 1150 may be similar to the UI 950 shown in FIG. 9B. For example, the UI 1150 may include element 1155 indicating a number of reviews left mentioning the amenity according to the determined sentiment. The UI 1150 may also include an amenity summary 1160 and a plurality of reviews 1165 that mention the selected amenity displayed in the UI 1150.

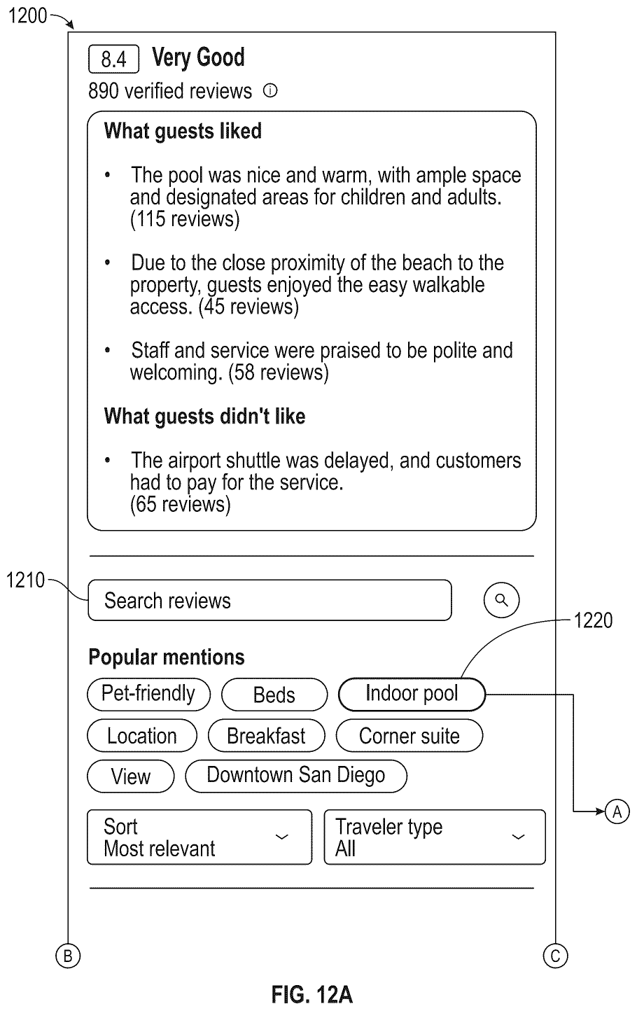

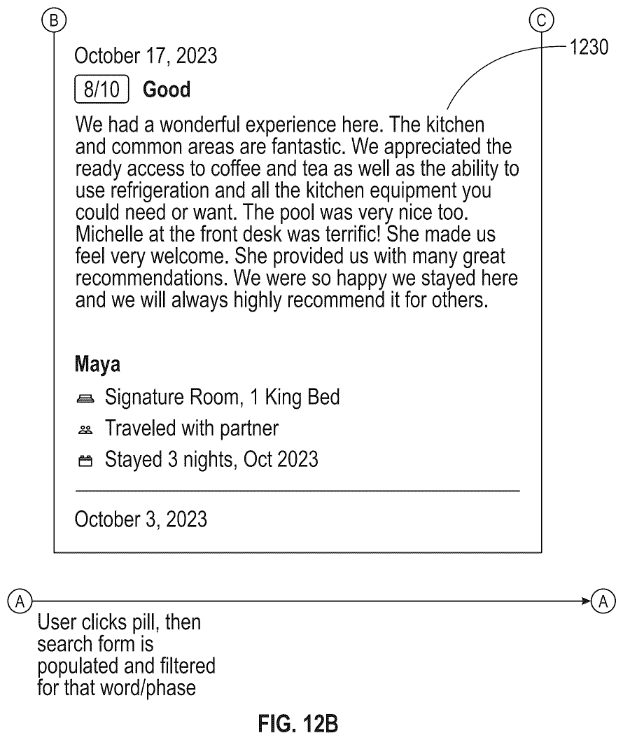

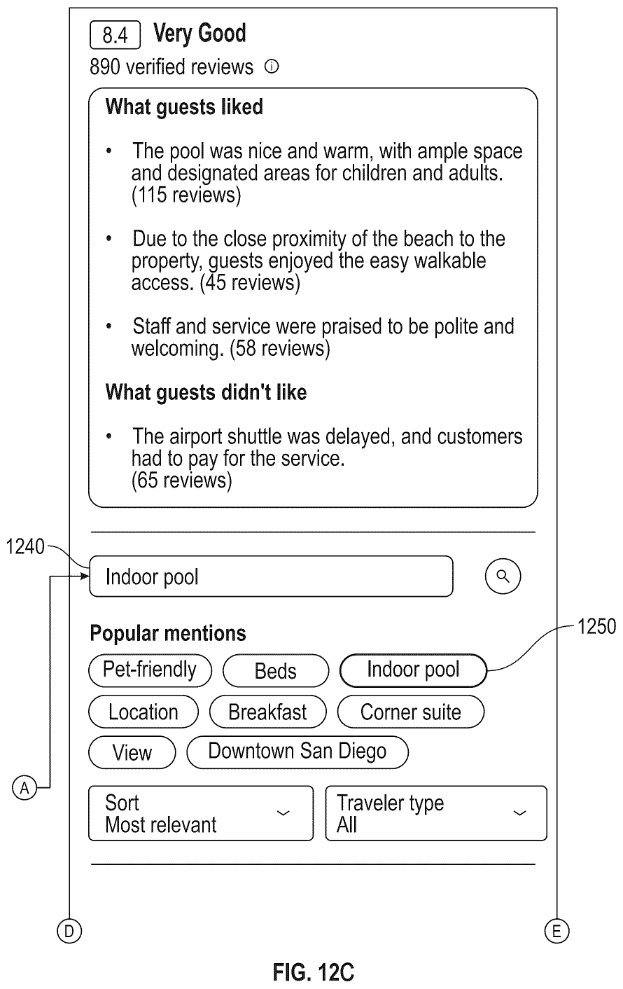

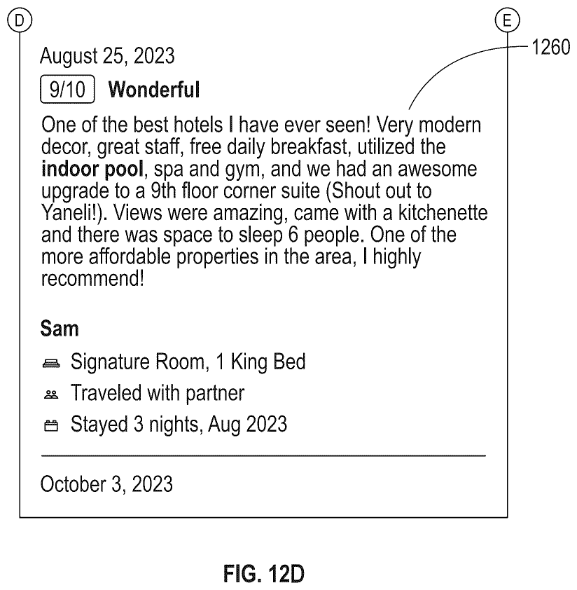

Referring now to FIGS. 12A-12D, a user interface (UI) 1200 is shown, according to an example embodiment. FIG. 12A shows a first portion of the UI 1200 and FIG. 12B shows a second portion of the UI 1200 (e.g., FIG. 12B shows a lower or “scrolled down” portion of the UI 1200). As shown in FIG. 12A, the UI 1200 may include a search bar 1210 and a plurality of popular mentions icons 1220. As shown in FIG. 12B, the UI 1200 further includes a plurality of reviews 1230. A user may search keywords and/or phrases in the search bar 1210, and, responsive to a receipt of an indication of the search by the content summarizer 130, the content summarizer 130 may cause the display to show only the reviews 1230 that include the searched text. The popular mentions icons 1220 may indicate amenities or aspects of the property that are most frequently mentioned in reviews. A user may select one of the popular mentions icons 1220 to view reviews mentioning the amenity or aspect corresponding to the select icon (shown as selected icon 1250). FIG. 12C shows a first portion of the UI 1200 and FIG. 12D shows a second portion of the UI 1200 (e.g., FIG. 12D shows a lower or “scrolled down” portion of the UI 1200) when an icon 1220 is selected. As shown in FIG. 12C, upon receipt by the content summarizer 130 of an indication of the user selecting the selected icon 1250, content summarizer 130 may cause the UI to display the search bar 1210 populated with the amenity corresponding to the selected icon 1250 (shown as search 1240). As shown in FIG. 12D, the reviews may update to shown reviews 1260 corresponding to the search 1240 and the selected icon 1250.

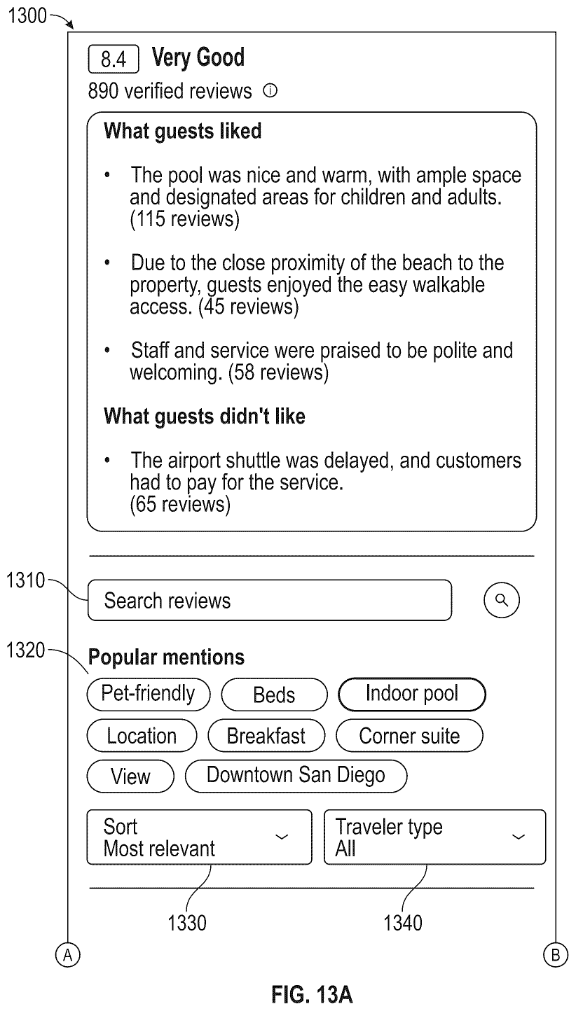

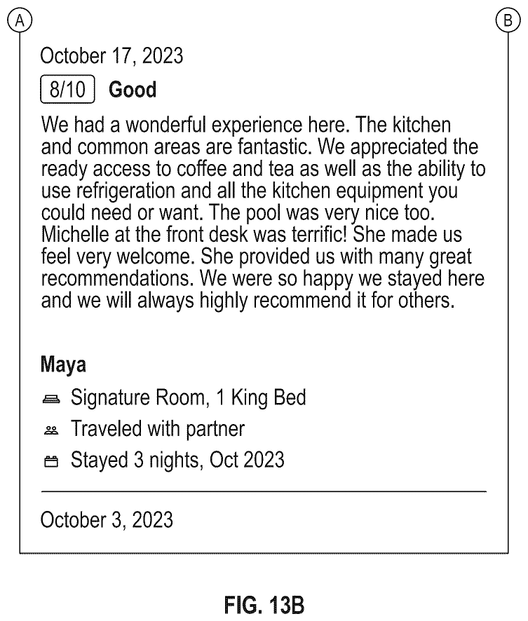

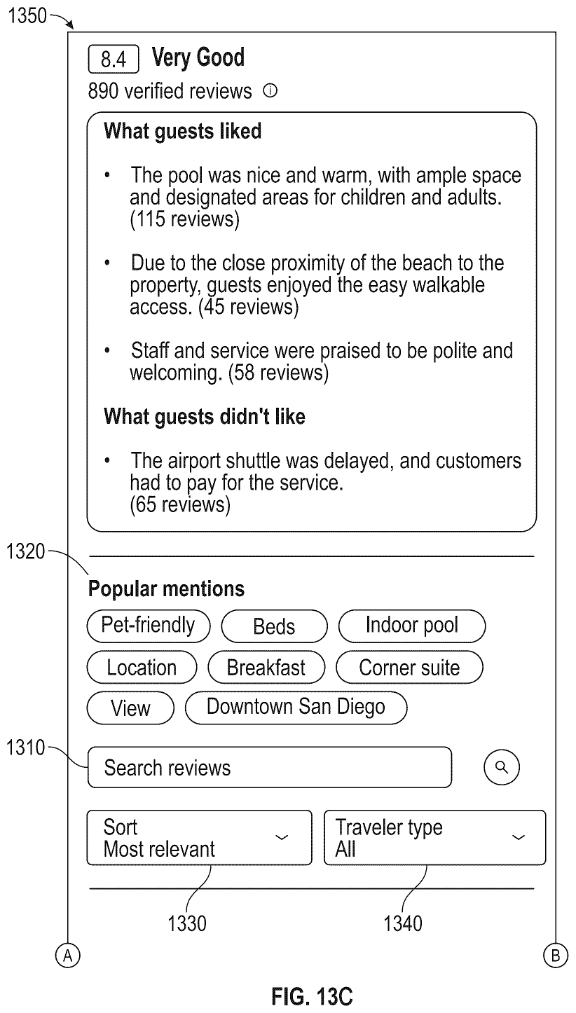

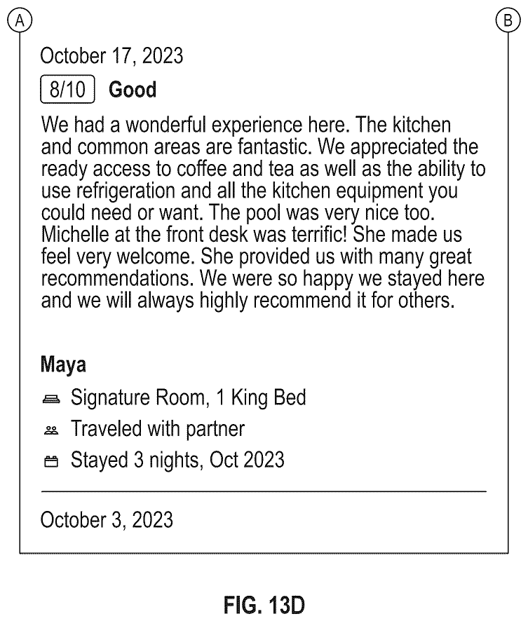

Referring now to FIGS. 13-13D, user interfaces (UIs) 1300 and 1350 are shown, according to an example embodiment. FIG. 13A shows a first portion of the UI 1300 and FIG. 13B shows a second portion of the UI 1300 (e.g., FIG. 13B shows a lower or “scrolled down” portion of the UI 1300). FIG. 13C shows a first portion of the UI 1350 and FIG. 13D shows a second portion of the UI 1350 (e.g., FIG. 13D shows a lower or “scrolled down” portion of the UI 1350). The UIs 1300 and 1350 may include similar elements to those described with respect to FIGS. 8-12. In various embodiments, the content summarizer 130 may cause the user interface displayed on the user device 140 to be displayed in different configurations while conveying the same information. For example, the content summarizer 130 may cause the UI 1300 to include the search bar 1310 positioned above the popular mention icons 1320 and the filters 1330 and 1340, as shown in FIG. 13A. However, the content summarizer 130 may cause the UI 1350 to include the popular mention icons 1320 positioned above the search bar 1310 and the filters 1330 and 1340, as shown in FIG. 13C.

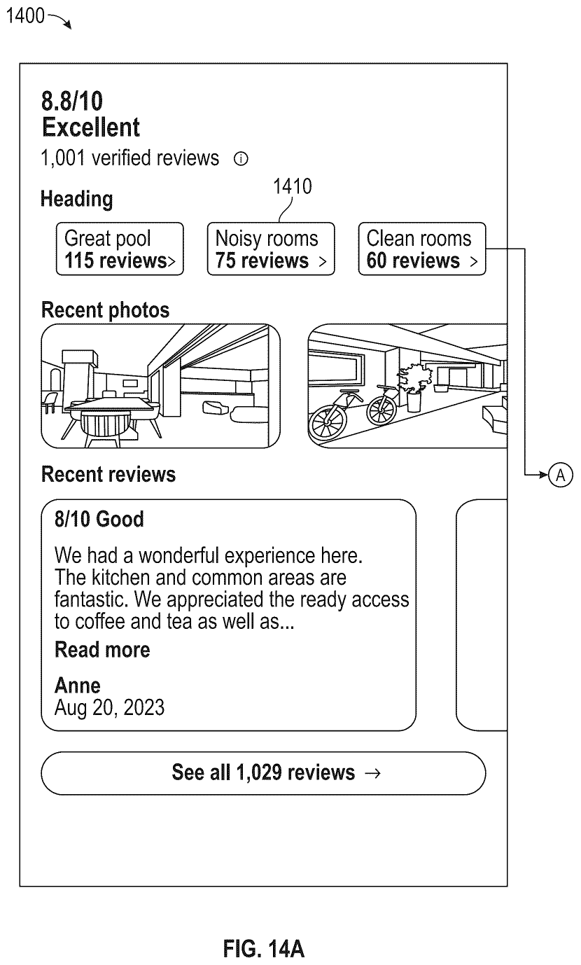

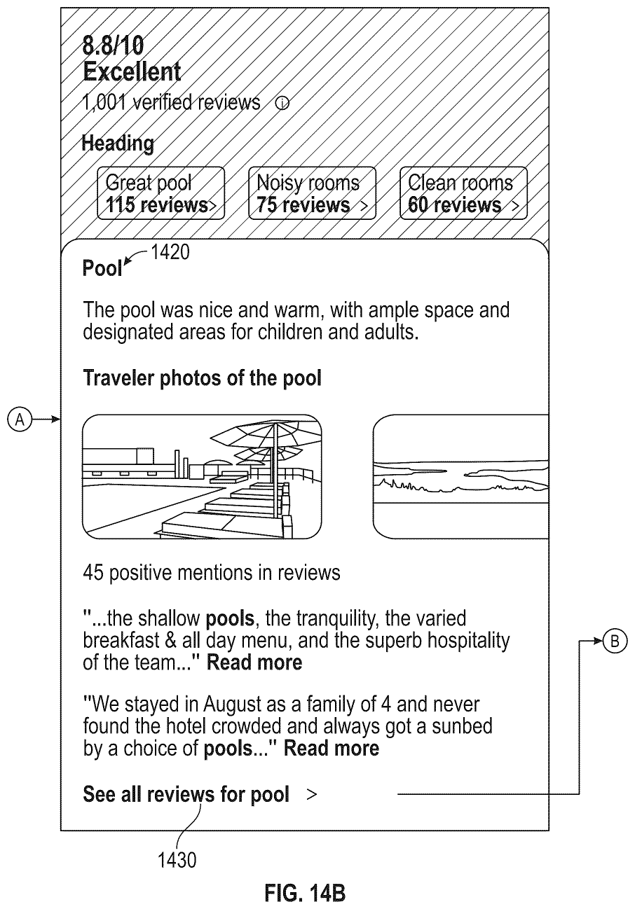

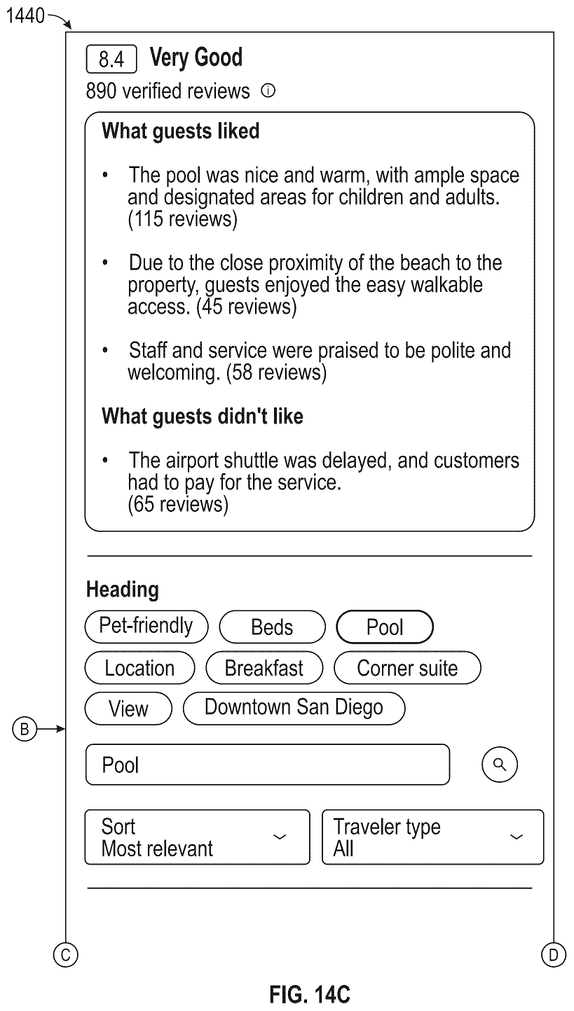

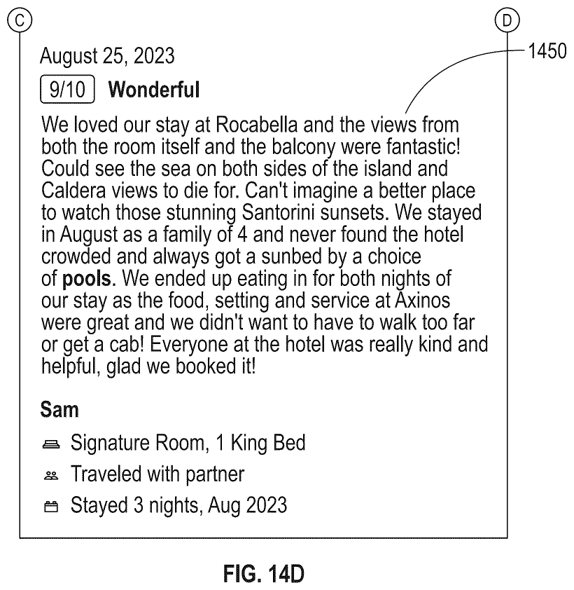

Referring now to FIGS. 14A-D, a user interface (UI) 1400 is shown, according to an example embodiment. The content summarizer 130 may generate the UI 1400, shown in FIG. 14A, to include a plurality of selectable amenity icons 1410. Upon receipt, by the content summarizer 130, of a user selecting an amenity icon 1410, the content summarizer 130 may generate a second UI 1420, shown in FIG. 14B. The UI 1420 may include additional information, such a generated amenity summary and a plurality of review excerpts mentioning the selected amenity. Option 1430 may be selected to view all reviews mentioning the selected amenity. Upon selecting option 1430, a third UI 1440 may be generated, shown in FIGS. 14C and 14D. FIG. 14C shows a first portion of the UI 1440 and FIG. 14D shows a second portion of the UI 1440 (e.g., FIG. 14D shows a lower or “scrolled down” portion of the UI 1440). The UI 1440 may include information such as an overall summary for the property and individual reviews 1450. The UI 1440 may display filtered 1450 such that the displayed reviews are only reviews that mention the selected amenity.

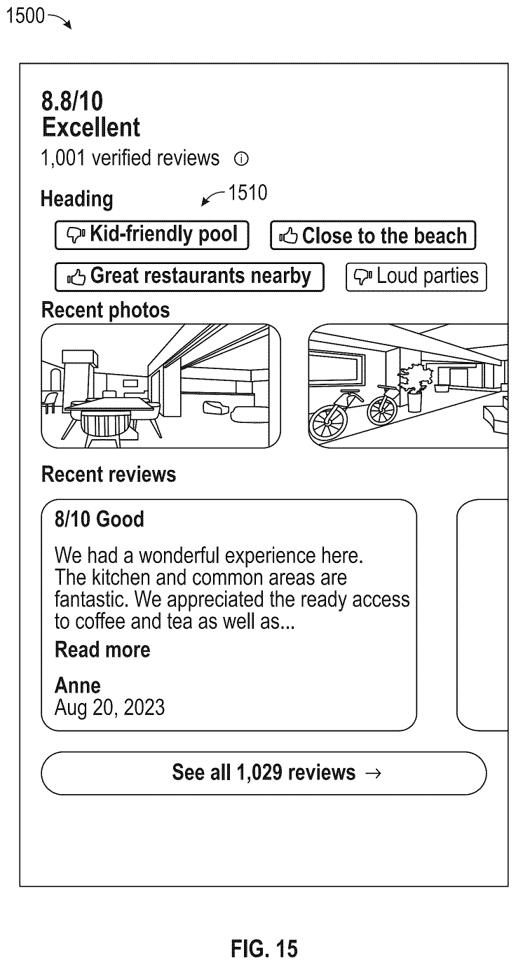

Referring now to FIG. 15, a user interface (UI) 1500 is shown, according to an example embodiment. The UI 1500 may include a plurality of amenity icons 1510. The content summarizer 130 may cause, based on a determined sentiment of the amenity by the sentiment and extraction system 134, the amenity icons 1510 may be displayed in different colors. For example, for amenities that have an overall positive sentiment based on the user reviews, the icon 1510 may be green. The amenity icons 1510 may further include an indicator indicating whether the sentiment is positive or negative. For example, an icon 1510 may include a “thumbs up” icon when the sentiment and extraction system 134 determines that the sentiment is positive and a “thumbs down” icon when the sentiment and extraction system 134 determines that the sentiment is negative.

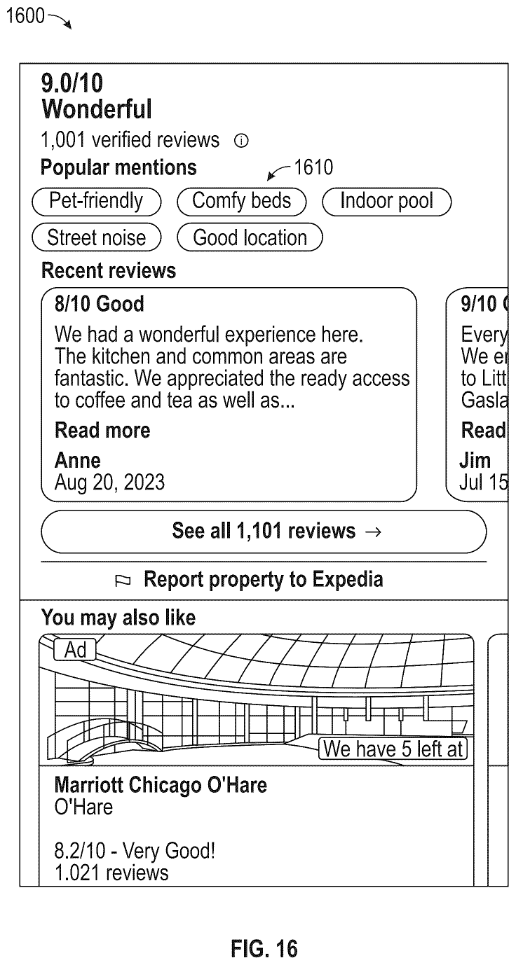

Referring now to FIG. 16, a user interface (UI) 1600 is shown, according to an example embodiment. The UI 1600 may include a plurality of amenity icons 1610. The amenity icons may be “pill” icons that do not indicate the associated sentiment.

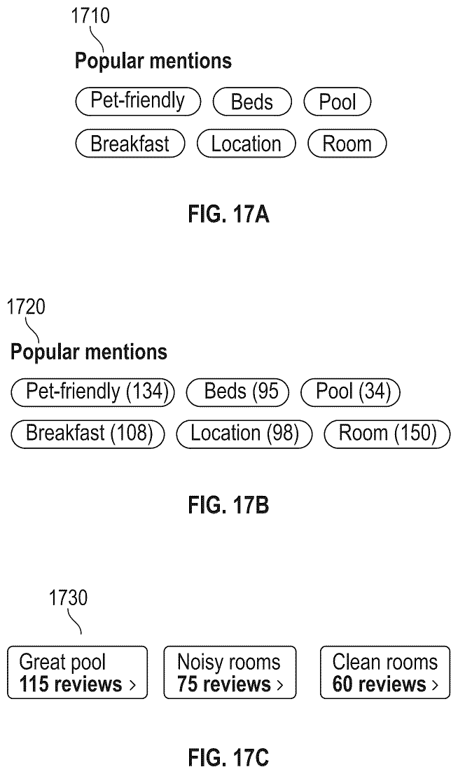

Referring now to FIGS. 17A-17C, elements 1710, 1720, and 1730 of a user interface are shown, according to an example embodiment. Referring specifically to FIG. 17A, popular mention icons 1710 are shown. The icons 1710 may include the name or title of the amenity or aspect. The icons may be oval, “pill” icons. Referring to FIG. 17B, popular mention icons 1720 are shown. The icons 1720 may include the name or title of the amenity and a number of individual user reviews that mention the specific amenity or aspect. The icons 1720 may be selectable to view only reviews that mention the selected amenity. Referring to FIG. 17C, popular mention icons 1730 are shown. The icons 1730 may be “block” icons. The icons 1730 may include a descriptor of the amenity and a number of reviews that mention the specific amenity. A user may select the icon 1730 to view the reviews related to the amenity.

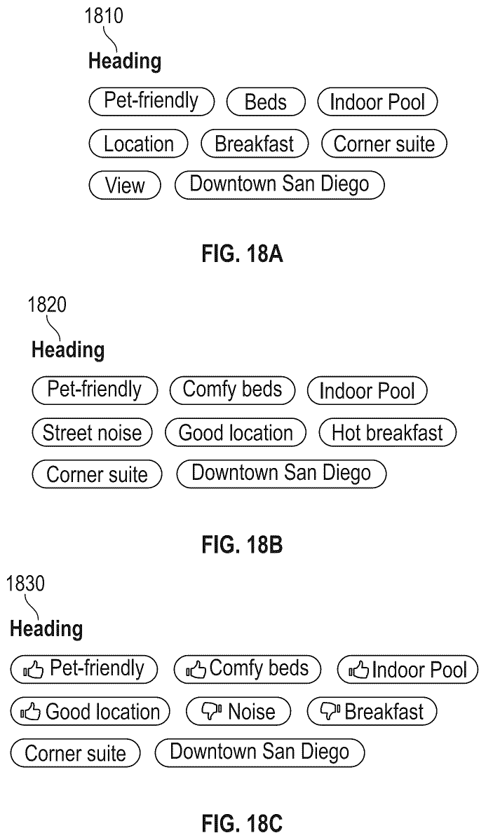

Referring now to FIGS. 18A-18C, elements 1810, 1820, and 1830 of a user interface are shown, according to an example embodiment. Referring to FIG. 18A, popular mention icons 1810 are shown. The icons 1810 may include only a name or title of the amenity. Referring to FIG. 18B, popular mention icons 1820 are shown. The icons 1820 may include a descriptor corresponding to a determined sentiment of the amenity based on the reviews mentioning the amenity. For example, an icon may state “comfy bed.” The descriptor “comfy” may be generated based on a determination that reviews mentioning the beds in a property are comfortable (e.g., rather than uncomfortable). Referring to FIG. 18C, popular mention icons 1830 are shown. The icons 1830 may include, in addition to the descriptors described with respect to FIG. 18B, sentiment indicators. For example, the content summarizer 130 may analyze the reviews for a property and, for each identified amenity or aspect of the property, determine a positive or negative sentiment. The content summarizer 130 may cause each popular mention icon 1830 to include an indicator, such as a thumbs up icon or a thumbs down icon, corresponding to the determined positive or negative sentiment.

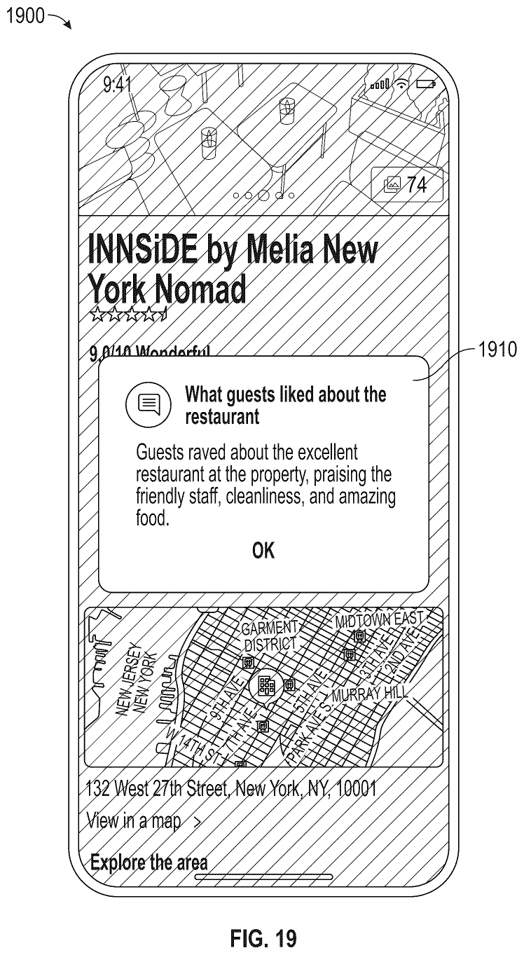

Referring now to FIG. 19, a user interface (UI) 1900 is shown, according to an example embodiment. The UI 1900 may include a generated overall summary for a property as a pop-up icon 1910. The icon 1910 may include only an overall summary (e.g., the user cannot select an amenity summary).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

The implementations described herein have been described with reference to drawings. The drawings illustrate certain details of specific implementations that implement the systems, methods, and programs described herein. Describing the implementations with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some implementations, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some implementations, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. In a non-limiting example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some implementations, the one or more processors may be embodied in various ways. The one or more processors may be constructed in a manner sufficient to perform at least the operations described herein. In some implementations, the one or more processors may be shared by multiple circuits (e.g., circuit A and circuit B may comprise or otherwise share the same processor, which, in some example implementations, may execute instructions stored, or otherwise accessed, via different areas of memory). Alternatively or additionally, the one or more processors may be structured to perform or otherwise execute certain operations independent of one or more co-processors.

In other example implementations, two or more processors may be coupled via a bus to enable independent, parallel, pipelined, or multi-threaded instruction execution. Each processor may be implemented as one or more processors, ASICs, FPGAs, GPUS, TPUs, digital signal processors (DSPs), or other suitable electronic data processing components structured to execute instructions provided by memory. The one or more processors may take the form of a single core processor, multi-core processor (e.g., a dual core processor, triple core processor, or quad core processor), microprocessor, etc. In some implementations, the one or more processors may be external to the apparatus, in a non-limiting example, the one or more processors may be a remote processor (e.g., a cloud-based processor). Alternatively or additionally, the one or more processors may be internal or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the implementations might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile or non-volatile memories), etc. In some implementations, the non-volatile media may take the form of ROM, flash memory (e.g., flash memory such as NAND, 3D NAND, NOR, 3D NOR), EEPROM, MRAM, magnetic storage, hard disks, optical disks, etc. In other implementations, the volatile storage media may take the form of RAM, TRAM, ZRAM, etc. Combinations of the above are also included within the scope of machine-readable media. In this regard, machine-executable instructions comprise, in a non-limiting example, instructions and data, which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative implementations. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementations,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of implementations has been presented for purposes of illustration and description. It is not intended to be exhaustive or to limit the disclosure to the precise form disclosed, and modifications and variations are possible in light of the above teachings or may be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes, and omissions may be made in the design, operating conditions, and implementation of the implementations without departing from the scope of the present disclosure as expressed in the appended claims.

What is claimed is:

1. A system for generating content summaries comprising:
a provider computing system including:
a first machine learning model configured to:
retrieve, from a third party, one or more elements associated with an entity associated with the third party; and
retrieve a plurality of content items associated with the entity, each content item of the plurality of content items including a reference to at least one of the one or more elements;
a second machine learning model configured to determine, for each reference to at least one of the one or more elements in each content item of the plurality of content items, a sentiment of the reference;
a third machine learning model configured to generate, for each reference to the at least one of the one or more elements, a first summary of the at least one of the one or more elements; and
a fourth machine learning model configured to generate a second summary, the second summary including the first summary of the at least one of the one or more elements.

2. The system of claim 1, wherein determining the sentiment of the reference further comprises weighting each content item of the plurality of content items based on an age of each content item, wherein the first summary is generated using the weight of each content item.

3. The system of claim 1, wherein the third machine learning model is further configured to determine one or more first summaries to display based on one or more user preferences of a user, each of the one or more first summaries corresponding to a different element of the one or more elements.

4. The system of claim 1, wherein the provider computing system is configured to present at least one of the first summary or the second summary via a user device associated with a user, wherein the presentation of at least one of the first summary or the second summary is varied based on an user preference of the user, and wherein at least one of the third or fourth machine learning models is further configured to:
receive user feedback from the user device regarding at least one of the first summary or the second summary;
update at least one of the first summary or the second summary based on the received user feedback; and
cause a display, via the user device, of the updated at least one of the first summary or the second summary.

5. The system of claim 4, wherein varying the presentation of at least one of the first summary or the second summary further comprises varying at least one of a tone, a length, a format, or a wording of at least one of the first summary or the second summary based on at least one of the user preferences or the received user feedback.

6. The system of claim 1, wherein the fourth machine learning model is further configured to post-process, upon generation of the first summary, the first summary to at least one of determine that information included in the plurality of content items used to generate the first summary is accurate or identify one or more portions of the first summary to be removed.

7. The system of claim 6, wherein the fourth machine learning model is further configured to, based on a determination that one or more pieces of information included in the plurality of content items used to generate the first summary is inaccurate, update the first summary to remove the determined one or more pieces of information that is inaccurate.

8. The system of claim 1, wherein each of the first summary and the second summary is a textual description.

9. The system of claim 1, wherein the third machine learning model is further configured to:
identify one or more changes in the sentiment of one least one reference used to generate the first summary;
update the first summary according to the one or more changes in the sentiment; and
generate and provide a notification to a user device associated with a user corresponding to the entity of the identified change in the sentiment.

10. A method for generating content summaries, the method comprising:
retrieving, by a first machine learning model of a provider computing system and from a third-party computing system, one or more elements associated with an entity associated with the third-party computing system;
retrieving, by the first machine learning model from storage of the provider computing system, a plurality of content items associated with the entity, each content item of the plurality of content items including a reference to at least one of the one or more elements;
determining, by a second machine learning model and for each reference to at least one of the one or more elements in each content item of the plurality of content items, a sentiment of the reference;
generating, by a third machine learning model and for each reference to the at least one of the one or more elements, a first summary of the at least one of the one or more elements; and
generating, by a fourth machine learning model, a second summary including the first summary of the at least one of the one or more elements.

11. The method of claim 10, wherein determining the sentiment of the reference further comprises weighting each content item of the plurality of content items based on an age of each content item, wherein the first summary is generated using the weight of each content item.

12. The method of claim 10, further comprising:
determining, by the third machine learning model, one or more first summaries to display based on one or more user preferences of a user, each of the one or more first summaries corresponding to a different element of the one or more elements.

13. The method of claim 10, wherein the provider computing system is configured to present at least one of the first summary or the second summary via a user device associated with a user, wherein the presentation of at least one of the first summary or the second summary is varied based on an user preference of the user, and wherein the method further comprises:
receiving, by at least one of the third or fourth machine learning model, user feedback from the user device regarding at least one of the first summary or the second summary;
updating, by at least one of the third or fourth machine learning model, at least one of the first summary or the second summary based on the received user feedback; and
causing, by at least one of the third or fourth machine learning model, a display, via the user device, of the updated at least one of the first summary or the second summary.

14. The method of claim 13, wherein varying the presentation of at least one of the first summary or the second summary further comprises varying at least one of a tone, a length, a format, or a wording of at least one of the first summary or the second summary based on at least one of the user preferences or the received user feedback.

15. The method of claim 10, further comprising:
post-processing, by the fourth machine learning model, upon generation of the first summary, the first summary to at least one of determine that information included in the plurality of content items used to generate the first summary is accurate or identify one or more portions of the first summary to be removed.

16. The method of claim 15, further comprising updating, by the fourth machine learning model, based on a determination that one or more pieces of information included in the plurality of content items used to generate the first summary is inaccurate, the first summary to remove the determined one or more pieces of information that is inaccurate.

17. The method of claim 10, further comprising:
generating a graphical user interface (GUI) comprising the first summary and the second summary; and
displaying the generated GUI via a user device.

18. The method of claim 10, further comprising:
identifying, by the third machine learning model, one or more changes in the sentiment of one least one reference used to generate the first summary;
updating, by the third machine learning model, the first summary according to the one or more changes in the sentiment; and
generating and providing, by the third machine learning model, a notification to a user device associated with a user corresponding to the entity of the identified change in the sentiment.

19. One or more non-transitory computer-readable media storing instructions thereon that, when executed by one or more processors, cause the one or more processors to perform operations comprising:
retrieving, by a first machine learning model, from a third party, one or more elements associated with an entity;
retrieving, by the first machine learning model, from a provider computing system, a plurality of content items associated with the entity, each content item of the plurality of content items including a reference to at least one of the one or more elements;
determining, by a second machine learning model, for each reference to at least one of the one or more elements in each content item of the plurality of content items, a sentiment of the reference;
generating, by a third machine learning model, for each reference to the at least one of the one or more elements, a first summary of the at least one of the one or more elements; and
generating, by a fourth machine learning model, a second summary, the second summary including the first summary of the at least one of the one or more elements.

20. The non-transitory computer-readable media of claim 19, wherein the instructions further cause the one or more processors to perform operations comprising:
generating a graphical user interface (GUI) to display on a user device, the GUI comprising the first summary, the second summary, and at least one of one or more images of the entity or one or more images of the at least one of the one or more elements.
